(19) United States
(12) Patent Application Publication
(10) Pub. No.: US 2026/0320231 A1
(43) Pub. Date: Oct. 15, 2026

(54) ANONYMIZING TIME-SERIES DATA USING MATRIX PROFILE

(71) Applicant: Visa International Service Association, San Francisco, CA (US)

(72) Inventors: Audrey Der, Riverside, CA (US); Michael Yeh, Newark, CA (US); Yan Zheng, Los Gatos, CA (US); Junpeng Wang, Santa Clara, CA (US); Huiyuan Chen, Mountain View, CA (US); Zhongfang Zhuang, San Jose, CA (US); Liang Wang, San Jose, CA (US); Wei Zhang, Fremont, CA (US)

(73) Assignee: Visa International Service Association, San Francisco, CA (US)

(21) Appl. No.: 19/108,404

(22) PCT Filed: Sep. 12, 2023
(86) PCT No.: PCT/US2023/073933

§ 371 Date: Mar. 3, 2025

Related U.S. Application Data
(60) Provisional application No. 63/406,688, filed on Sep. 14, 2022.

(51) Int. Cl. G06F 21/62

(52) U.S. Cl. CPC G06F 21/6254

(57) ABSTRACT

Methods and systems for anonymizing time-series data are disclosed. An anonymizing computer can generate an anonymized sequence of time-series data that can share many useful properties, patterns, or characteristics with a private sequence of time-series data, without revealing sensitive or private information about the private sequence of time-series data. This may enable data researchers and scientists to study the anonymized sequence of time-series data in lieu of the private sequence of time-series data, thereby preserving the privacy of data subjects (e.g., people) corresponding to the private sequence of time-series data. The anonymized sequence of time-series data can be generated using an iterative optimization process that can involve updating the anonymized sequence of time-series data to minimize a loss value. The loss value can correspond to both the utility and privacy of the anonymized sequence of time-series data.

### CROSS-REFERENCE TO RELATED APPLICATIONS

This application is a PCT application, which claims priority to and claims the benefit of U.S. Provisional Application No. 63/406,688, filed on Sep. 14, 2022, which is herein incorporated by reference in its entirety for all purposes.

### BACKGROUND

Time-series data can refer to sequences of data values that are associated with time. In time-series data, each “time-series data value” may be associated with a corresponding “time value” or “timestamp,” which may indicate the time associated with a particular time-series data value, and which may enable the time-series data to be ordered, analyzed, and/or displayed chronologically. Other data, such as “indices” or “indicators” may be used to indicate the relative order of time-series data values.

There are many different types of time-series data. For example, many forms of medical data, such as electrocardiogram (ECG), respiration rate, blood pressure, daily white blood cell count (WBC), data collected from smartwatches or wearable fitness devices (such as heart rate data, accelerometer data during sleep tracking, etc.), can all comprise time-series data. Other examples of time-series data include home utility consumption data, such as gallons of water consumed per day, kWh of power consumed per day, gas usage, etc. Transaction data (e.g., relating to debit and credit card transactions) and stock prices can also comprise time-series data.

Many scientific disciplines (such as signal processing and data mining) are dedicated to the analysis of time-series data. For example, by analyzing heartrate time-series data, scientists and doctors can identify heartrate patterns that may be predictive of heart attacks or other diseases. As another example, by analyzing home power consumption time-series data, civil engineers can predict the power demands of particular cities or geographic regions and increase the capacity and production of their power grid to accommodate this demand. As a third example, by analyzing time-series credit card transaction data, a payment processing network can identify patterns of spending that may be indicative of fraud. As such, it can be useful for members of the data mining and data analysis communities to publish or share time-series data, in order to encourage collaboration and lead to innovations or other new and useful discoveries.

However, many forms of time-series data are sensitive or private. The data subjects (e.g., people) corresponding to those time-series data may not want their data to be published or become publicly available. For example, a person may not want to disclose sensitive medical information, e.g., in order to avoid discrimination or stigmatization based on that medical information. Additionally, some time-series data may enable individuals to make inferences about data subjects beyond what is explicitly disclosed in the time-series data. For example, it may be possible to determine the age or sex of a data subject based on that data subject's ECG data, even if the ECG data (or any associated metadata) does not explicitly or directly disclose this information. In some cases, such data may be controlled or protected by privacy rules and regulations, such as HIPAA [29], GDPR [2], and PIPA [1].

This poses a problem for the analysis of this time-series data. While useful information can be learned from the analysis of time-series data, data researchers and other scientists have an ethical, social, and in some cases legal responsibility to protect the privacy of data subjects or other data doners. As such, it is difficult for scientists and researchers to publish or otherwise share sensitive time-series data and comply with information privacy laws, which discourages the development and publication of useful time-series data.

Embodiments address these and other problems, individually and collectively.

### SUMMARY

Embodiments of the present disclosure are directed to methods and systems for generating anonymized sequences of time-series data from private sequences of time-series data. Some methods according to embodiments may use a “matrix profile” to generate anonymized sequences of time-series data. As such, some methods and systems according to embodiments may be referred to by the acronym “TSAUMP”, which stands for “Time-Series Anonymization Using the Matrix Profile.”

Anonymized sequences of time-series data (generated using embodiments of the present disclosure) can be published, analyzed, and/or studied in lieu of the private sequences of time-series data, which may comprise sensitive or otherwise private information that may be protected by privacy rules and regulations. In this way, data scientists and other researchers can learn from the private sequences of time-series data without gaining access to the sensitive information contained therein. “Private sequences of time-series data can include any suitable any suitable input sequences of time-series data that is to be anonymized. In some embodiments, the private sequence of time series data comprises user health data (e.g., EKGs), utilities data, computer data or financial data.

In summary, an anonymizing computer can generate an anonymized sequence of time-series data that satisfies one or more of a “privacy-preserving condition”, a “utility-preserving condition” and a “cosmetic condition.” In general, the privacy-preserving condition can indicate that the anonymized sequence of time-series data generally preserves the privacy of the private sequence of time-series data, e.g., that malicious individuals cannot recover sensitive information from the private sequence of time-series data using the anonymized sequence of time-series data. As described in more detail below, the anonymizing computer can achieve the privacy-preserving condition by generating an anonymized sequence of time-series data that is largely uncorrelated with the corresponding private sequence of time-series data, which can make it difficult (or in some cases impossible) to make inferences about the private sequence of time-series data by evaluating the anonymized sequence of time-series data, thereby preserving the privacy of the private sequence of time-series data.

The utility-preserving condition can indicate that an anonymized sequence of time-series data is useful for analysis or data mining operations, e.g., that the anonymized sequence of time-series data preserve enough useful information from a corresponding private sequence of time-series data that data analysis can be performed on the anonymized sequence of time-series data instead of the private sequence of time-series data, and achieve similar results as performing the data analysis on the private sequence of time-series data directly. As described in more detail below, a series of experiments demonstrate that anonymized sequences of time-series data preserve enough information to perform data mining operations such as motif mining, discord mining, anomaly detection, semantic segmentation, and clustering, thereby demonstrating the effectiveness of methods and systems according to embodiments.

In more detail, the anonymizing computer can satisfy the utility-preserving condition by using a matrix profile to preserve structural information or other high level patterns (sometimes referred to as “motifs” or “discords”) from the private sequence of time-series data in the anonymized sequence of time-series data. This enables data scientists and researchers to study and draw useful conclusions from the anonymized sequence of time-series data.

In some embodiments, the anonymizing computer can satisfy the cosmetic condition by generating the anonymized sequence of time-series data such that it has similar “cosmetic” characteristics as the private sequence of time-series data, such as its complexity and variability. Preserving these cosmetic characteristics can be useful if data scientists or other researchers intend to study the variability or complexity of time-series data.

The anonymizing computer can generate the anonymized sequence of time-series data using an iterative, loss-based optimization process. Prior to the iterative process, the anonymizing computer can generate an initial anonymized sequence of time-series data, which can be improved in a series of iterative process rounds until it generally satisfies one or more of the conditions described above. To do so, the anonymizing computer can calculate a “loss” or “loss value” (sometimes also referred to as an “error” or “error value”) that can relate the desired characteristics of the anonymized sequence of time-series data to its actual characteristics. By repeatedly updating the anonymized sequence of time-series data to reduce the loss, the anonymizing computer can generate an anonymized sequence of time-series data that satisfies one or more of the conditions described above. In some embodiments, the loss can comprise a combined loss, which may comprise a weighted combination of a plurality of losses. Each loss from this plurality of losses can correspond to one or more of the conditions described above, e.g., the privacy preserving condition, the utility-preserving condition, and the cosmetic condition. Some of these losses may be determined using a matrix profile and may be referred to as “matrix profile losses”.

In more detail, one embodiment is directed to a method for generating an anonymized sequence of time-series data from a private sequence of time-series data. In this method, an anonymizing computer can receive a private sequence of time-series data comprising one or more private time-series data values. The anonymizing computer can determine a matrix profile and a matrix profile index based on the private sequence of time-series data. The anonymizing computer can initialize the anonymized sequence of time-series data. The anonymized sequence of time-series data can comprise one or more anonymized time-series data values. The anonymizing computer can perform an iterative process to update the anonymized sequence of time-series data. In the iterative process, the anonymization computer can sample a batch of anonymized subsequences from the anonymized sequence of time-series data. The anonymization computer can determine a batch of anonymized subsequence indicators corresponding to the batch of anonymized subsequences. The batch of anonymized subsequence indicators can comprise one or more anonymized subsequence indicators. The anonymizing computer can determine a loss based on the batch of anonymized subsequences, the batch of anonymized subsequence indicators, the private sequence of time-series data, the matrix profile, and the matrix profile index. The anonymization computer can update the anonymized sequence of time-series data based on the loss. The anonymization computer can repeat this iterative process until a terminating condition has been met. The anonymizing computer can provide the anonymized sequence of time-series data to a client computer.

Another embodiment is directed to a method of evaluating an anonymization method (such as the method described above). A computer system can receive a private sequence of time-series data comprising one or more private time-series data values and an anonymized sequence of time-series data comprising one or more anonymized time-series data values. The anonymized sequence of time-series data may have been generated by an anonymizing computer based on the private sequence of time-series data using the anonymization method. The computer system can analyze the private sequence of time-series data using an analysis procedure, thereby producing a private analysis result. The computer system can likewise analyze the anonymized sequence of time-series data using the analysis procedure, thereby producing an anonymous analysis result. The computer system can generate a private score based on the private analysis result and a scoring mechanism. Likewise, the computer system can generate an anonymous score based on the anonymous analysis result and the scoring mechanism. The computer system can evaluate the anonymization method by comparing the private score to the anonymous score.

Other embodiments are directed to systems for performing methods described herein, such as the methods described above. Such systems can include, for example, an anonymizing computer comprising a processor and a non-transitory computer readable medium coupled to the processor. The non-transitory computer readable medium can comprise code or instructions, executable by the anonymizing computer for performing methods described herein.

### Terms

A “server computer” may refer to computer or cluster of computers. A server computer may be a powerful computing system, such as a large mainframe. Server computers can also include minicomputer clusters or a group of servers functioning as a unit. In one example, a server computer can include a database server coupled to a web server. A server computer may comprise one or more computational apparatuses and may use any of a variety of computing structures, arrangements, and compilations for servicing requests from one or more client computers.

A “memory” may refer to any suitable device or devices that may store electronic data. A suitable memory may comprise a non-transitory computer readable medium that stores instructions that can be executed by a processor to implement a desired method. Examples of memories include one or more memory chips, disk drives, etc. Such memories may operate using any suitable electrical, optical, and/or magnetic mode of operation.

A “processor” may refer to any suitable data computation device or devices. A processor may comprise one or more microprocessors working together to accomplish a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and or Xscale; and/or the like processor(s).

“Time-series data” may refer to any data for which data elements have associated time values, such that the time-series data can be ordered and interpreted chronologically. “Private time-series data” or “sensitive time-series data” may refer to time-series data for which the data elements are private, sensitive, or intended to be anonymized. Private time-series data may be protected by laws or regulations that prevent its distribution. Time-series data may comprise sequences of time-series data, e.g., multiple time-series data values presented or stored chronologically. “Subsequences” of time-series data values can be derived from such sequences of time-series data values. A subsequence of time-series data values can comprise one or more sequential time-series data values from a sequence of time-series data values.

“Data values” may refer to values representative of data. Data values can comprise numbers, as well as other forms of data, such as strings, or any other data (e.g., a computer file), etc. A data value can comprise a univariate data value (e.g., a single value) or a multivariate data value (e.g., multiple values). Time-series data may comprise sequences of data values with associated timestamps or indices.

“Anonymized data” may refer to data (e.g., time-series data values) that masks or hides (e.g., anonymizes) some aspect of the data used to derive the anonymized data. “Anonymized time-series data” or “anonymized sequences of time-series data” may refer to time-series data or sequences of time-series data that have been anonymized.

A “window” may refer a framed area that is used to determine a contiguous subset of time-series data. A window or subsequence may be defined by a “window length” or a “subsequence length,” which may determine a number of time-series data values in the window or subsequence, or alternatively may define a time range over which the window or subsequence is defined.

A “loss” or “loss value” (also referred to as an “error” or “error value”) may refer to a metric used to compare the performance of something (e.g., a machine learning mode, or a data set) relative to the expected, intended, or desired performance. Loss values can be used to train machine learning models.

A “correlation,” “correlation value,” or “correlation coefficient,” may refer to a number used to define how correlated two or more datasets are. A correlation can indicate a functional, mathematical, or probabilistic relationship between two datasets which may enable the inference of information regarding one dataset from the other. Two correlated datasets are generally more similar than two uncorrelated datasets.

An “anomaly” or “discord” may refer to some data within a dataset that is different from the rest of the data in the dataset. A “motif” or “pattern” may refer to some data within a dataset that repeats throughout the dataset. Detecting motifs or patterns is a common goal of machine learning applications.

### BRIEF DESCRIPTION OF THE DRAWINGS

FIG. 1 shows an exemplary application for time-series anonymization methods according to some embodiments.

FIG. 2 shows an exemplary time-series data curation and data anonymization system according to some embodiments.

FIG. 3 shows an exemplary distance profile constructed from a reference sequence of time-series data.

FIG. 4 shows an exemplary AB-join matrix profile constructed from an exemplary first sequence of time-series data and an exemplary second sequence of time-series data.

FIG. 5 shows an exemplary self-join matrix profile constructed from an exemplary sequence of time-series data, which can be used for discord mining.

FIG. 6 shows an exemplary self-join matrix profile constructed from an exemplary sequence of time-series data, which can be used for motif mining tasks.

FIG. 7 shows a flowchart of an exemplary time-series anonymization method according to embodiments.

FIG. 8 shows a graph comparing the complexity of different exemplary sequences of time-series data values.

FIG. 9 shows a flowchart of an exemplary method for determining one or more private subsequence complexity values according to some embodiments of the present disclosure.

FIG. 10 shows a flowchart of an exemplary method for determining loss values according to embodiments, which can be performed as part of a time-series anonymization method according to embodiments.

FIG. 11 shows a diagram summarizing an evaluation of anonymized sequences of time-series data and private sequences of time-series data.

FIG. 12 shows a flowchart of an exemplary method for comparing anonymized sequences of time-series data to private sequences of time-series data according to some embodiments.

FIGS. 13A, 13B, and 13C show flowcharts for methods of determining a nearest-neighbor loss, a non-nearest-neighbor loss, and a correlation loss according to some embodiments.

FIG. 14 shows a diagram comparing private subsequences and their private nearest-neighbor subsequences, and corresponding anonymized subsequences and their anonymized nearest-neighbor subsequences.

FIG. 15 shows a diagram comparing a private subsequence of time-series data and an anonymized sequence of time-series data used in the determination of a correlation loss.

FIG. 16A shows a flowchart of an exemplary method of determining a first complexity loss according to some embodiments.

FIG. 16B shows a flowchart of an exemplary method of determining a second complexity loss according to some embodiments.

FIG. 16C shows a flowchart of an exemplary method of determining a nearest-neighbor complexity loss according to some embodiments.

FIG. 17 shows a diagram comparing the matrix profiles of private sequences of time-series data and anonymized sequences of time-series data for a discord mining and a motif mining experiment.

FIG. 18 shows a system block diagram of an exemplary anonymizing computer according to some embodiments.

### DETAILED DESCRIPTION

As described above in the summary, embodiments are directed to methods and systems for generating anonymized sequences of time-series data from private sequences of time-series data (also referred to more generically as “input sequences of time-series data”). Using an iterative optimization process, an anonymizing computer can generate an anonymized sequence of time-series data that meets one or more of a privacy-preserving condition, a utility-preserving condition, and a cosmetic condition, in order to produce an anonymized sequence time-series data that preserves the privacy of a corresponding private sequence of time-series data while still retaining useful structural or pattern information. Such structural or pattern information can enable data researchers or other scientists to analyze and draw useful conclusions from the anonymized sequence of time-series data, allowing researchers or scientists to use the anonymized sequence of time-series data instead of the private sequence of time-series data for research or analysis, thereby preserving the privacy of data subjects (e.g., people) corresponding to the private sequence of time-series data.

Several previous methods have been proposed for anonymizing time-series data [11, 22, 33, 35, 38, 39]. Some of this previous work focuses on time-series data corresponding to specific domains [11, 22, 39], while other previous works attempt to design methods for general time-series data [33, 35, 38]. For example, Shou et al. [35]proposed a time-series anonymization method based on the (k, P)-anonymity privacy model [35], which is extended from k-anonymity [36]. Under the (k, P)-anonymity privacy model, a set of time-series are separated into different groups or sub-groups, and the privacy of each time-series in the set is protected by using generalized quasi-identifiers and shared pattern representation. Differential privacy [3] is another privacy paradigm studied for time-series data [38]. Particularly, Wang et al. [39]proposed a privacy-preserving time-series generative model, called PART-GAN which extends the conditional generative adversarial network [27] to guarantee differential privacy.

Unlike the previous work described above, methods according to embodiments can be used to directly produce an anonymized sequence of time-series data from a private sequence of time-series data, without needing any additional information. By contrast, Shou et al. [35] and the PART-GAN method [39] both require multiple time-series in a database to perform anonymization. As such, methods according to embodiments are less data intensive and can be executed by an anonymization computer quicker and more efficiently.

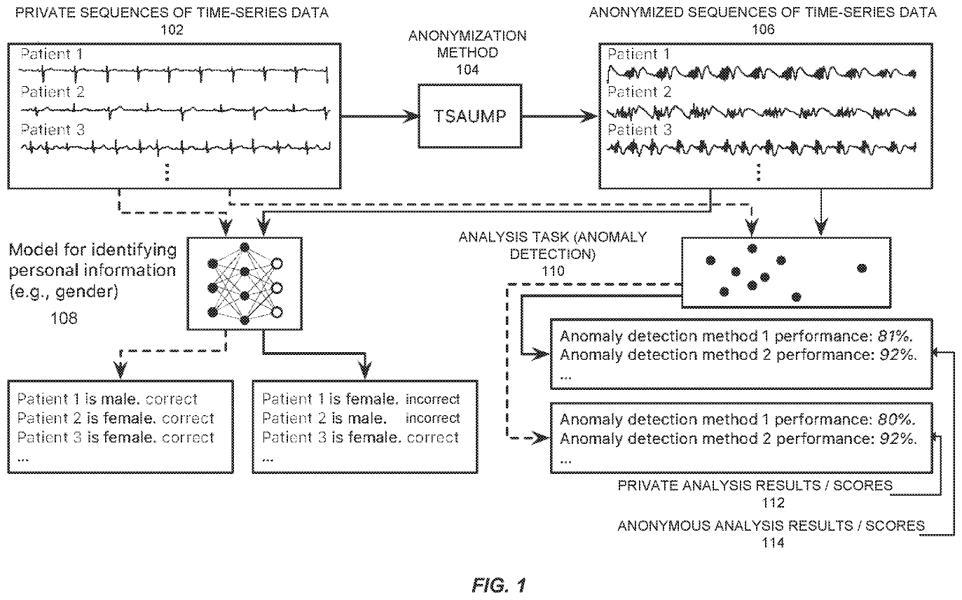

FIG. 1 illustrates some potential privacy risks associated with publishing private sequences of time-series data and further shows an exemplary use case for methods and systems according to embodiments. FIG. 1 demonstrates how anonymized sequences of time-series data 106 can be used for data analysis tasks (e.g., analysis task 110) in lieu of private sequences of time-series data 102, but cannot be used to identify private or otherwise personal information, unlike the private sequences of time-series data 102 used to derive the anonymized sequences of time-series data 106.

In more detail, FIG. 1 shows three exemplary private sequences of time-series data 102 comprising electrocardiogram (ECG) signals corresponding to three patients. These ECG signals could be published or otherwise released to the public as a time-series anomaly detection benchmark dataset. Such data could be released without any accompanying metadata containing personal information, in order to protect the patients' data privacy. However, a malicious individual may be able build a gender prediction model 108 capable of identifying private personal information based on this ECG benchmark dataset. Such a gender prediction model 108 could be built using other ECG data in the public domain [17]. Using this gender prediction model 108, the malicious individual could use the private sequences of time-series data 102 to determine each patient's respective gender, thereby invading each patient's privacy.

However, by using an anonymization method 104 according to embodiments (TSAUMP), an anonymizing computer can generate anonymized sequences of time-series data 106 corresponding to the private sequences of time-series data 102. The anonymized sequences of time-series data 106 may have different local patterns, but may still maintain general structural information from the private sequences of time-series data 102. The malicious individual's gender prediction model 108 may be unable to determine the correct genders of the patients because the shape of the “heartbeats” in the anonymized sequences of time-series data 106 may no longer conform to typical, public domain ECG data used to train or otherwise construct the gender prediction model 108.

Further, the preservation of general global structure enables the anonymized sequences of time-series data 106 to be used for a variety of analysis tasks, such as an anomaly detection analysis task 110, in place of the private sequences of time-series data 102. When the anonymized sequences of time-series data 106 are analyzed using the analysis task 110, they may achieve similar analysis results or scores as the private sequences of time-series data 102, indicated in FIG. 1 by the similarity between private analysis results or scores 112 and anonymous analysis results or scores 114. As such, data researchers can use the anonymized sequences of time-series data 106, instead of the private sequences of time-series data 102 for meaningful data analysis, thereby preserving the privacy of the private sequences of time-series data 102 and any corresponding data subjects or data donors.

As described further below, experiments were conducted to evaluate whether it was possible to build a model to accurately predict gender (and age) information from ECG data, whether anonymization methods according to embodiments could anonymized time-series data such that the model would be unable to accurately predict such information from anonymized sequences of ECG data, and whether anonymized sequences of ECG data could be used for anomaly detection tasks and achieve similar results to corresponding private sequences of ECG data. In summary, the experiments generally demonstrated that it was possible to build a model to accurately predict gender (and age) information from ECG data, that such models are unable to predict gender and age information based on anonymized sequences of time-series data, and that anomaly detection tasks could generally be performed on anonymized sequences of time-series data instead of private sequences of time-series data. In this way, these experiments demonstrate the effectiveness of methods and systems according to embodiments of the present disclosure.

Although FIG. 1 shows an example use case corresponding to ECG data, it should be understood that anonymization methods according to embodiments of the present disclosure can be used in a variety of different contexts, particularly contexts in which it may be desirable to preserve the privacy of time-series data or data subjects corresponding to that time-series data. Different actions can be taken after analyzing anonymized time-series data. As one example, time-series data corresponding to home electricity, water, or gas usage can be used to determine the production or capacity needs of a municipality at different times of day or year, with respect to those resources. However, individuals may not want to share private time-series data corresponding to their resource usage, as it may enable others to determine, for example, when that individual is at their home, when they are away from home, etc. Using embodiments of the present disclosure however, private sequences of time-series data corresponding to electricity, water, or gas usage could be anonymized prior to analysis, thereby preserving the privacy of homeowners or renters. The anonymized time-series data can be analyzed to determine anomalies and actions can be taken. For example, the anonymized time-series data relating to water usage may indicates that a certain set of homeowners are experiencing a sharp increase in water usage. An action such as performing an automatic leak detection process can be initiated.

As yet another example, anonymization methods according to embodiments of the present disclosure could enable cyber security auditors to evaluate the security of a computer network while preserving the privacy of communications transmitted over that network. In some conventional network audits, the auditor may evaluate packets and other messages transmitted between computers and devices on the network in order to evaluate security risks. However, these packets may contain private information that the auditor would preferably not have access to. These packets or other network communications received over a defined period of time (e.g., one day) can be treated as time-series data values in a private sequence of time-series data, and methods according to embodiments can be used to produce an anonymized sequence of time-series data from this private sequence of time-series data. The auditor could evaluate this anonymized sequence of time-series data in order to evaluate the security of the computer network, thereby preserving the privacy of network communications over that network. The anonymized time-series data can be analyzed to determine anomalies and actions can be taken. For example, security patches or other remedial efforts can be initiated to address any security issues relating to any anomalous data from the anonymized time-series data.

It should be understood that the examples provided above are intended to be non-limiting, and embodiments of the present disclosure can be used in a wide variety of other applications. As yet another example, time-series data corresponding to bank transfers could be anonymized using methods according to embodiments, and the resulting anonymized sequences of time-series data could be used to detect fraud or financial crimes without invading the privacy of bank account holders. As another example, time-series data corresponding to a smart car's global positioning system, speed, and fuel consumption could be used to diagnose problems with the operation of the smart car (e.g., engine malfunctions that may reduce fuel efficiency) without revealing private information about the owner of the smart car (e.g., locations where the owner is driving the car or the times at which the owner is visiting those locations). The anonymized time-series data can be analyzed to determine anomalies and actions can be taken in the above two examples. For example, an action can be taken to close accounts associated with potential financial crime, or corrective actions such as over-the-air updates can be sent to the above-described smart care to address any issues relating to anomalies in the anonymized time-series data.

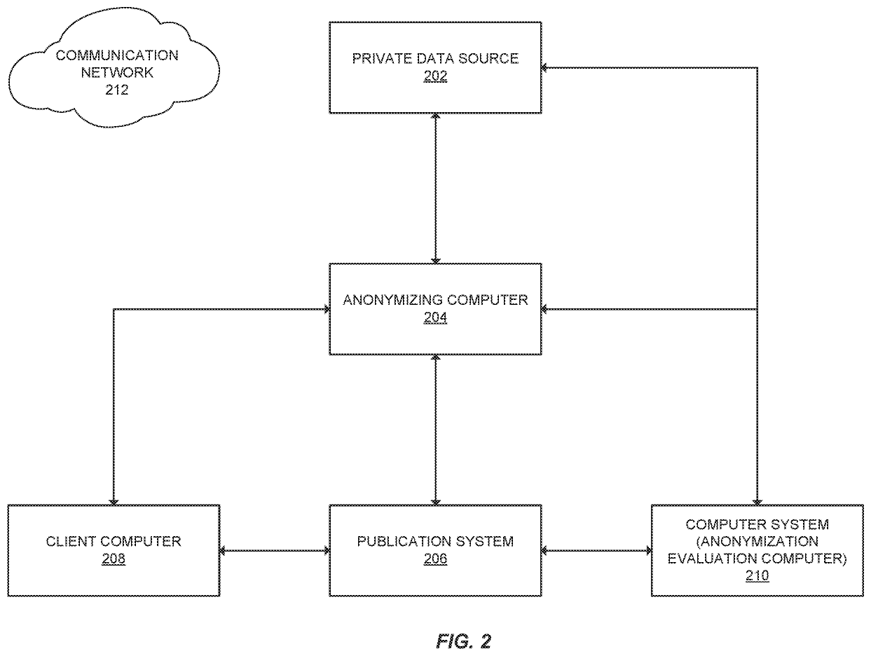

FIG. 2 shows a data curation system comprising an anonymizing computer 204, which can comprise a computer system that can perform some methods according to embodiments. The anonymizing computer 204 can interface with a private data source 202 to receive private sequences of time-series data. The private data source 202 can comprise a database of private sequences of time-series data, or can comprise a “data curator”, an entity that manages and safeguards private sequences of time-series data. For example, the private data source 202 could comprise a medical research institute that collects private sequences of time-series data from medical research experiments. In some cases, the anonymizing computer 204 may be affiliated with the private data source 202, e.g., the anonymizing computer 204 may comprise a computer system owned and/or operated by a data curator, such as a medical research institute. In other cases, the anonymizing computer 204 may be associated with an entity trusted by the private data source 202 to anonymize private sequences of time-series data.

Using methods according to embodiments, the anonymizing computer 204 can generate anonymized sequences of time-series data from the private sequences of time-series data received from the private data source 202. The anonymization computer 204 can then publish these anonymized sequences of time-series data, or otherwise make them available to other computer systems or entities. For example, in some embodiments, publishing the anonymized sequences of time-series data can comprise transmitting the anonymized sequences of time-series data to a client computer, such as client computer 208. This client computer 208 could comprise, for example, a computer system owned and/or operated by a data scientist or other member of the data mining community, who may analyze the anonymized sequences of time-series data as part of their research. As an alternative, the anonymizing computer 204 can publish the anonymized sequences of time-series data using a publication system 206, which may comprise, e.g., a publicly available webserver that computer systems (such as client computer 208) can access to retrieve the anonymized sequence of time-series data.

FIG. 2 additionally shows a computer system 210, which may be referred to as an “anonymization evaluation computer.” This computer system 210 can evaluate the effectiveness of anonymization methods implemented using the anonymizing computer 204. For example, the computer system 210 can perform a data mining or other data evaluation task (such as analysis task 110 in FIG. 1) on both a private sequence of time-series data and a corresponding anonymized sequence of time-series data, in order to verify that the anonymized sequence of time-series data generally produces similar analysis results as the private sequence of time-series data when analyzed.

The computer system 210 may receive the private sequence of time-series data from the private data source 202 and receive the anonymized sequence of time-series data from the anonymizing computer 204 or the publication system 206. In some cases, the computer system 210 may comprise the anonymizing computer 204, i.e., the anonymizing computer 204 itself may evaluate the effectiveness of anonymization methods according to embodiments. Alternatively, the computer system 210 may be associated with the private data source 202, e.g., a data curator may use the computer system 210 to evaluate the effectiveness of anonymization methods according to embodiments. As yet another alternative, the computer system 210 may comprise the client computer 208.

The devices, computers, and other entities in FIG. 2 can communicate with one another via one or more communication networks, such as communication network 212. Communication network 212 can take any suitable form, and may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a wireless application protocol (WAP), I-mode, and/or the like); and/or the like. Messages between the computers, entities, and other devices in FIG. 2 may be transmitted using a communication protocol such as, but not limited to, File Transfer Protocol (FTP); Hypertext Transfer Protocol (HTTP); Secure Socket Layer (SSL), ISO (e.g., ISO 8583) and/or the like.

Before describing methods and systems according to embodiments in more detail, it may be helpful to describe some concepts related to time-series analysis and anonymization, including the matrix profile. Additionally, a more formal description of a “time-series anonymization problem” is provided below.

For ease of explanation, embodiments of the present disclosure are generally described from the perspective of univariate sequences of time-series data. However, it should be understood that embodiments of the present disclosure can be practiced using multivariate sequences of time-series data as well. A univariate sequence of time-series data T can comprise a sequence of time-series data values tᵢ, i.e., T=[t₁, t₂, . . . , tₙ] where n is the length of T. Sequences of time-series data can generally be interpreted as vectors, which can comprise one dimensional sequential arrays of elements. T=[115 mmHg, 150 mmHg, 121 mmHg] is an example of a vector comprising three systolic blood pressure data elements. Each time-series data element in T could correspond to an observation time or time period, which can be indicated by a timestamp or another appropriate time value. For example, each blood pressure measurement could be recorded one month apart, and therefore the sequence of time-series data T could correspond to a three month time period.

Vectors (and therefore sequences or subsequences of time-series data represented by vectors) can be “indexed” using an “index”, “indices”, or “indicators.” For example, by “indexing” T=[115 mmHg, 150 mmHg, 121 mmHg] with indicator “3”, the third data value in T can be identified or retrieved, i.e., T[3]=121 mmHg. The term “index” is used somewhat ambiguously in the field of time-series analysis, and can mean either an individual indicator (e.g., “3”) or a set or vector of indicators (e.g., [1, 2, 3]). In the present disclosure, the term index typically refers to a set of indicators, and the term indicator typically refers to a single indicator.

Sometimes, data mining and data analysis tasks are performed on local patterns or “subsequences” of time-series data. A subsequence of time-series data can comprise a contiguous subset of time-series data values derived from a sequence of time-series data. Indicators can be used for the purpose of identifying or extracting subsequences of time-series data from sequences of time-series data. For example, T[2, 3]=[150 mmHg, 121 mmHg] can comprise a subsequence comprising the second and third time-series data elements from T. Throughout this disclosure, subsequences are often defined based on an indicator i and a subsequence length m. As such, a subsequence “T_{i,m}” can comprise a contiguous subset of m values from a sequence of time-series data T starting at indicator i. For example, T_{2,2}=[150 mmHg, 121 mmHg] can comprise a subsequence of time-series data beginning at the second element of T with a subsequence length of two.

Sometimes sequences and subsequences of time-series data can be compared to evaluate their similarities or differences. “Distances” or “distance metrics” are ways to quantify the similarity or difference between two sequences or subsequences of time-series data. To compute distances, vectors representing sequences or subsequences of time-series data can be interpreted as position vectors, pointing to two points in vector space. A distance can comprise the distance between these two points, which can comprise, e.g., the magnitude of the difference between the two position vectors. Some embodiments of the present disclosure use Euclidean distance (the distance between points in Euclidean space) in order to quantify the difference between two sequences or subsequences of time-series data. Other techniques, such as determining the angle between two vectors representing sequences or subsequences of time-series data can be used to evaluate the similarity of those sequences. The cosine similarity can be used for this purpose.

Z-normalization can refer to a process by which elements of a dataset can be normalized such that the dataset has a mean μ=0 and a standard deviation σ=1. A normalized dataset Xₙₒᵣₘ can be produced from a dataset X using the formula:

$${X}_{norm} = \frac{X - {μ}_{X}}{σ}$$

(substitutions can be made for sample standard deviation s if necessary). Such datasets can comprise sequences or subsequences of time-series data, and therefore such sequences or subsequences of time-series data can be z-normalized. The “z-normalized Euclidean distance” [45, 46] can comprise the Euclidean distance between two z-normalized sequences or subsequences of time-series data, and can be used to measure the similarity or difference between those sequences or subsequences of time-series data.

A “distance profile”

$$D {P}_{i , m}^{A B}$$

can comprise a vector of distances (e.g., Euclidean distances or z-normalized Euclidean distances) between a subsequence of time-series data

$${T}_{i , m}^{A}$$

(sometimes referred to as a “query subsequence”) and each subsequence (typically of equal length m) in a sequence of time-series data T^{B}. In this way, a distance profile can be used to identify subsequences in a time-series T^{B} that are similar to the subsequence

$${T}_{i , m}^{A} .$$

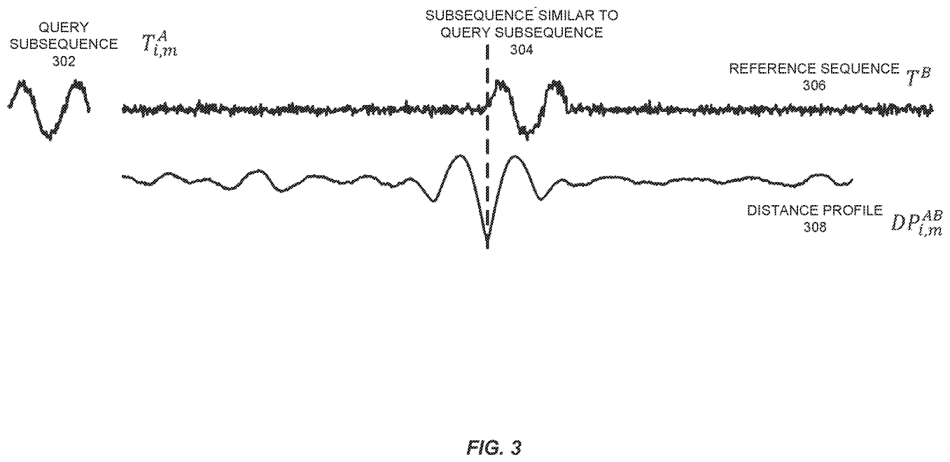

FIG. 3 shows an exemplary query subsequences of time-series data 302

$${T}_{i , m}^{A} ,$$

a reference sequence of time-series data 306 T^{B}, and a corresponding distance profile 308

$$D {P}_{i , m}^{A B} .$$

The reference sequence of time-series data 306 contains a subsequence of time-series data 304 that is similar to the query subsequence of time-series data 302. The value of the distance profile 308 (indicated by its amplitude) indicates the similarity between the query subsequence of time-series data 302 and subsequences of time-series data in the reference sequence of time-series data 306. Notably, the value of the distance profile 308 is at its lowest at the indicator corresponding to the subsequence of time-series data 304 that is similar to the query subsequence of time-series data 302, which may be referred to as the “nearest-neighbor” of the query sequence of time-series data 302. Stated differently, the “nearest-neighbor” subsequence of a query subsequence of time-series data is the subsequence that is the most similar to the query subsequence in the entire sequence of time-series data. The distance between a subsequence of time-series data and its nearest-neighbor may be referred to as a “nearest-neighbor distance.” As such, FIG. 3 illustrates how a distance profile can be used to identify subsequences in sequences of time-series data, particularly nearest-neighbor subsequences of time-series data.

A “matrix profile”

$$M {P}_{m}^{A B}$$

is an effective and versatile tool for time-series data mining [20, 40, 47]. It is similar to a distance profile in that it relates the distance between subsequences in sequences of time-series data. However, while a distance profile describes the distance between a subsequence of time-series data (e.g., a query subsequence as described above) and each subsequence of time-series data in a sequence of time-series data (e.g., a reference sequence as described above), a matrix profile describes the distance between each subsequence of a first sequence of time-series data and its nearest-neighbor subsequence in a second subsequence of time-series data. As such, a matrix profile [45, 46] can comprise a vector that summarizes a collection of distance profiles.

More formally, a matrix profile

$$M {P}_{m}^{A B}$$

can comprise a vector of distances (e.g., Euclidean distances or z-normalized Euclidean distances) between each subsequence

$${T}_{i , m}^{A}$$

in a first sequence of time-series data T^{A} and its nearest neighbor subsequence

$${T}_{j , m}^{A}$$

in a second sequence of time-series data T^{B}. That is,

$$M {P}_{m}^{A B} = [ min ( D {P}_{2 , m}^{A B} ) , … , min ( D {P}_{n - m + 1 , m}^{A B} ) ] .$$

Matrix profiles are useful in data analysis tasks such as motif discovery [42, 45], discord discovery [44, 45], anomaly detection [4, 24, 25], semantic segmentation [15, 16], and many more tasks [20, 40, 41, 43, 47]. The matrix profile can often be computed efficiently [48, 49].

These definitions above are provided for cases in which the first sequence of time-series data T^{A} and the second sequence of time-series data T^{B} may or may not be the same time-series. When the first sequence of time-series data T^{A} and the second sequence of time-series data T^{B} are the same sequence, i.e., T^{A}=T^{B}, the corresponding matrix profile may be referred to as a “self-join” matrix profile. When the first sequence of time-series data and the second sequence of time-series data are not the same, i.e., T^{A}≠T^{B}, it may be referred to as the “AB-join” matrix profile.

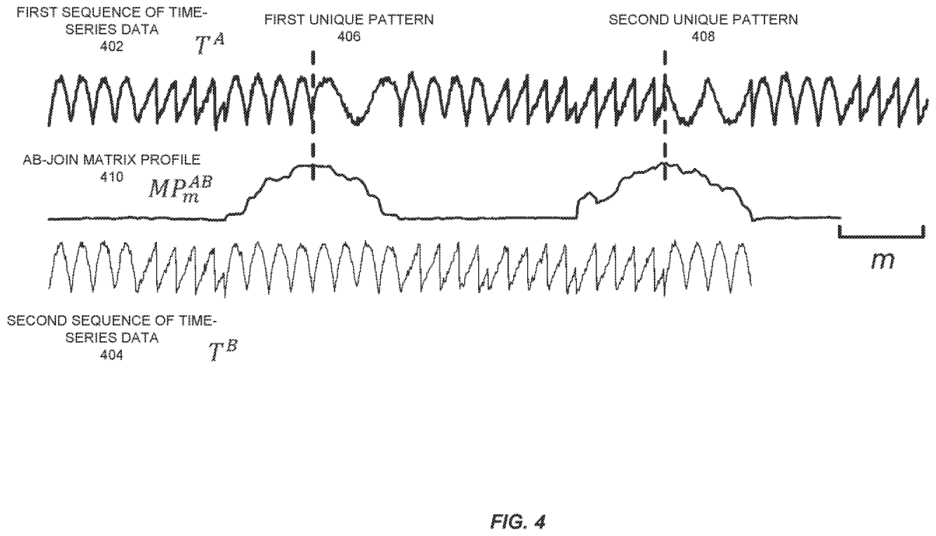

FIG. 4 shows an AB-join matrix profile 410 constructed from a first sequence of time-series data 402 T^{A} and a second sequence of time-series data 404 T^{B}. A subsequence length of m was used to construct the AB-join matrix profile 410. The first sequence of time-series data 402 contains a first unique pattern 406 and a second unique pattern 408. As described above, the AB-join matrix profile 410 indicates the distance between each subsequence in the first sequence of time-series data 402 and its nearest neighbor subsequence in the second sequence of time-series data 404. Because the first sequence of time-series data 402 and the second sequence of time-series data 404 are mostly identical, the value of the AB-join matrix profile is generally near zero. However, the value of the AB-join matrix profile increases near the indicators corresponding to the first unique pattern 406 and second unique pattern 408, as these unique patterns are not present in the second sequence of time-series data 404, and consequently the distance to their “nearest-neighbors” is higher than usual. As such, FIG. 4 demonstrates how the matrix profile (particularly the AB-join matrix profile) can be used to identify unique patterns in sequences of time-series data. If the second sequence of time-series data 404 is considered “normal,” then the first unique pattern 406 and second unique pattern 408 can be considered “anomalies,” demonstrating how the matrix profile can be used to detect abnormal or anomalous subsequences of time-series data [44].

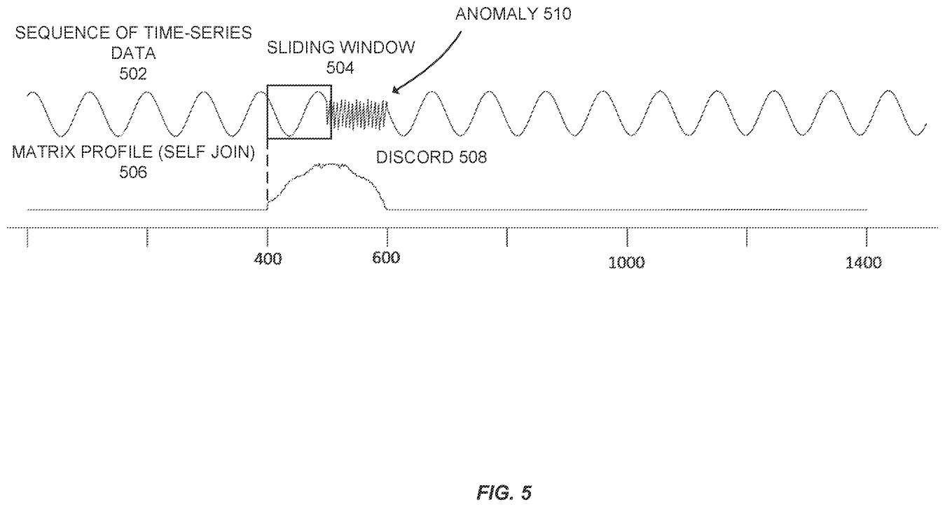

FIG. 5 shows a “self-join” matrix profile 506 corresponding to a sequence of time-series data 502. The self-join matrix profile 506 can be computed by determining the distance between each subsequence in the sequence of time-series data 502 and its nearest neighbor subsequence (ignoring “trivial matches”, i.e., a given subsequence and itself). A “sliding window” 504 may define each subsequence of time-series data in the sequence of time-series data 502 as it moves from left to right across the sequence of time-series data 502. The sequence of time-series data 502 contains an anomaly 510. Because there are few subsequences that contain this anomaly 510, subsequences containing this anomaly generally have a high distance between themselves and their nearest-neighbor subsequences. Consequently, the value of the self-join matrix profile 506 increases as the sliding window 504 moves across the anomaly 510. A “peak” in a matrix profile may be referred to as a “discord” and may indicate the location of an anomaly. In FIG. 5, discord 508 indicates the location of anomaly 510. Thus, FIG. 5 illustrates how matrix profiles can be used for discord mining and anomaly detection in sequences of time-series data [44].

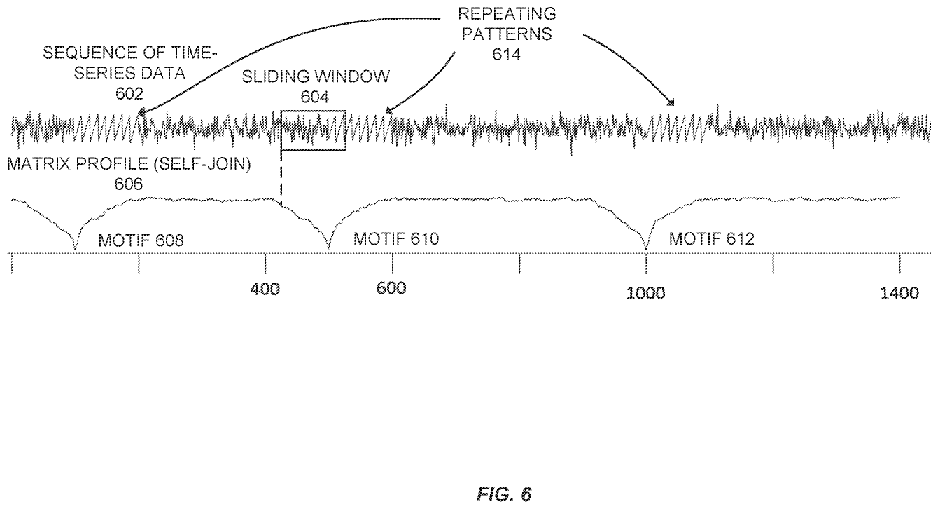

FIG. 6 depicts an additional use for self-join matrix profiles. FIG. 6 shows a sequence of time-series data 602, which generally comprises random noise, but also contains repeating patterns 614. A sliding window 604 can define the length of a subsequence, and can be used to determine the value of the self-join matrix profile 606 at corresponding indicators. Because the sequence of time-series data 602 generally comprises random noise, most subsequences are dissimilar to even their nearest-neighbor subsequences, and consequently the value of self-join matrix profile 606 is generally high. However, the repeating patterns 614 are similar to one another. Consequently, as the sliding window 604 moves over the repeating patterns 614, the value of the self-join matrix profile 606 decreases. Such “valleys” in a matrix profile are sometimes referred to as “motifs” [42], which can indicate the location of a repeating pattern (also referred to as a motif) in a sequence of time-series data. In FIG. 6, motifs 608, 610, and 612 indicate the location of the repeating patterns 614. Thus, FIG. 6 illustrates how matrix profiles can be used for motif mining and the detection of patterns in sequences of time-series data.

Having described some useful concepts related to time-series analysis and anonymization, it may be useful to describe the “time-series anonymization problem” in more detail. In general, the process of time-series anonymization involves generating an anonymized sequence of time-series data T corresponding to a given input sequence of time-series data T (e.g., a private sequence of time-series data T). Preferably, an anonymized sequence of time-series data satisfies at least two conditions.

The first of these conditions can be referred to as a “privacy-preserving condition” (or other similar terms such as “privacy condition”, “privacy criteria”, etc.). The privacy-preserving condition can indicate that the anonymized sequence of time-series data maintains the privacy of the corresponding private sequence of time-series data, e.g., the anonymized sequence of time-series data does not contain (or contains very little) information that would allow a malicious individual to learn private information corresponding to the private sequence of time-series data.

Correlation is one means to determine or estimate generally how much information one sequence of time-series data (e.g., an anonymized sequence of time-series data) communicates about another sequence of time-series data (e.g., a private sequence of time-series data). The Pearson correlation, for example, can comprise a value between −1 and 1 which indicates the linear correlation between two datasets (e.g., sequences or subsequences of time-series data). A correlation value of 0 indicates that the datasets are uncorrelated, meaning that no information about one dataset can be determined based on a linear relationship between the two datasets. A correlation value of 1 indicates that the datasets are totally linearly correlated, meaning that for any observation in one dataset (e.g., an individual time-series data value) there is an identical observation in the other dataset. A correlation value of −1 indicates that the datasets are totally negatively correlated, meaning that for any observation in one dataset, there is a corresponding negative observation in the other dataset.

As such, an anonymized sequence of time-series data values (or an anonymization method used to generate such an anonymized sequence of time-series data values) can be said to satisfy the privacy condition if c(T, \hat{T})≈0, where c(⋅,⋅) is a correlation metric. This can safeguard against malicious entities trying to recover the private sequence of time-series data from the anonymized sequence of time-series data, as the solution to argmin_{\hat{T}}(c(T, \hat{T})²) is not unique.

The second of these condition can be referred to as a “utility-preserving condition,” (or other similar terms such as “utility condition”, “utility criteria”, etc.) which indicates that the anonymized sequence of time-series data is “useful” for data mining or other data analysis. For example, an anonymized sequence of time-series data can be said to satisfy the utility condition if performing a data analysis method d(⋅) on the anonymized sequence of time-series data generally achieves similar performance (measured, e.g., using a scoring mechanism s(⋅)) as performing the data-analysis method on the corresponding private sequence of time-series data, i.e., s(d(T))≈s(d(\hat{T})). In other words, for a set of time-series data mining methods or tasks D, d(T)≈d(\hat{T})∀d ∈D. That is, generally speaking, performing a data mining method or task d on the anonymized sequence of time-series data i generally produces the same result as performing that same data mining method on the private sequence of time-series data T, for all tasks d in D. As an example, if the data-analysis method is a motif detection method, then motifs should generally be detected at the same rate and at the same locations in the private sequence of time-series data as in the anonymized sequence of time-series data.

As described in more detail below, embodiments of the present disclosure can use the matrix profile [45, 46] to approximately satisfy d(T)≈d(\hat{T})∀d ∈D by enforcing MatrixProfile(T)≈MatrixProfile(\hat{T}). By preserving the matrix profile from the private sequence of time-series data to the anonymized sequence of time-series data, the anonymized sequence of time-series data can retain enough information to succeed on many tasks, particularly common tasks in data mining or data analysis applications, such as anomaly detection.

In some cases, the privacy condition and utility conditions can be somewhat at odds, as illustrated by the following examples. A straightforward and effective way to satisfy the privacy condition is to generate an anonymized sequence of time-series data comprising random values independent from the private sequence of time-series data. Because of their randomness and independence, it is impossible to determine any information about the private sequence of time-series data from the anonymized sequence of time-series data. However, such an anonymized sequence of time-series data would not satisfy the utility condition, as it is not useful for data mining or other data analysis. Likewise, a straightforward and effective way to satisfy the utility condition is to generate an anonymized sequence of time-series data that is identical to the private sequence of time-series data, as it would lead to identical results for any deterministic data analysis or data mining method. However, this anonymized sequence of time-series data would not satisfy the privacy condition, as it directly reveals the private sequence of time-series data. Usually, for anonymization techniques such as differential privacy, this dilemma is managed by establishing privacy parameters (such as epsilon and delta) which controls “how much privacy” an anonymization method provides. Increasing this privacy can result in lower utility, and as such, data scientists often determine privacy parameters that achieve a good balance between privacy and utility.

Other conditions or criteria can also be applied to the time-series anonymization problem in order to generate anonymized sequences of time-series data that have desirable characteristics. For example, some embodiments of the present disclosure use an optional “cosmetic loss” to enforce a “cosmetic criteria”, which encourages the anonymizing computer to generate anonymized sequences of time-series data that have many of the same cosmetic features of the private sequences of time-series data, such as their variability and complexity.

It should be understood that the time-series anonymization problem can be formulated in a variety of ways and a variety of conditions or criteria can be introduced, e.g., in order to generate anonymized time-series data that possesses any number of desirable characteristics. Further, the use of correlation (such as the Pearson correlation) to enforce the privacy preserving condition and the matrix profile to enforce the utility preserving condition are only one of many possible approaches to the time-series anonymization problem described above, and that other such approaches may become apparent upon reading the present disclosure.

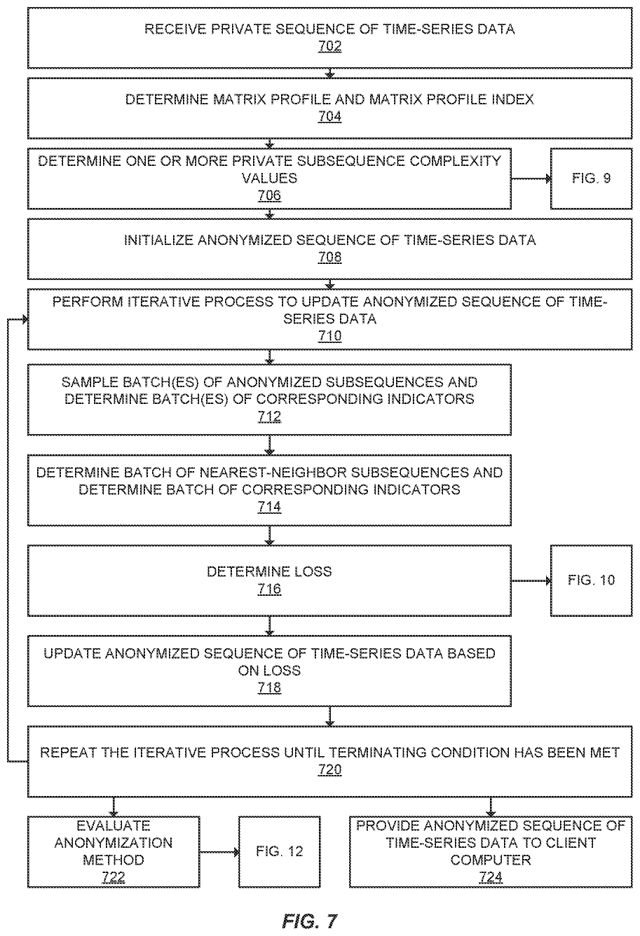

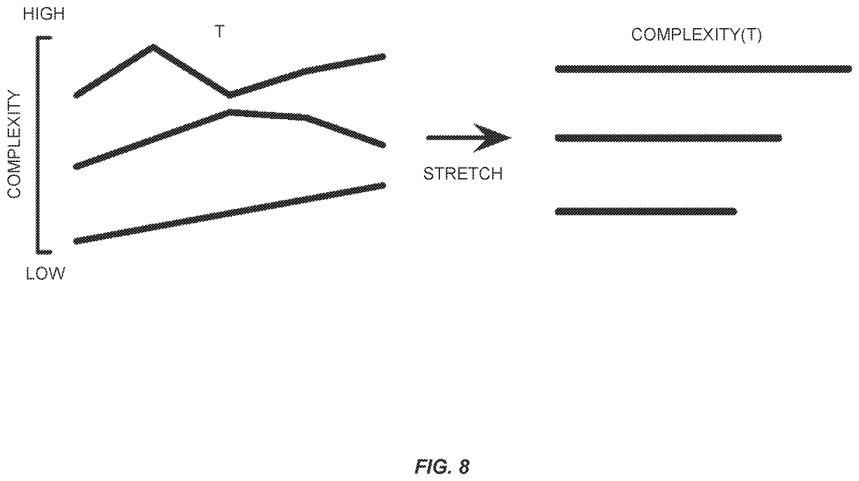

Having described the time-series anonymization problem and other useful background concepts, methods according to embodiments are described in more detail below with reference to the flowchart of FIG. 7, and additionally with reference to FIGS. 8, 9, 10, 12, 11, 13A-13C, 15, 14, and 16A-16C. In general, a time-series anonymization method according to embodiments can comprise three phases, including a pre-iterative process phase (e.g., corresponding to steps 702-708 in FIG. 7), an iterative process (e.g., corresponding to steps 710-720 in FIG. 7), and a post-iterative process phase (e.g., corresponding to steps 722 and 724 in FIG. 7).

In general, the pre-iterative process phase can involve steps performed by the anonymizing computer to set up or otherwise prepare for the iterative process. These steps can involve receiving a private sequence of time-series data, initializing an anonymized sequence of time-series data, and determining or otherwise preparing information that may be used during the iterative process, such as determining a matrix profile and matrix profile index, determining private subsequence complexity values (which may be later used to determine a complexity loss), etc.

At step 702, an anonymizing computer can receive a private sequence of time-series data T comprising one or more private time-series data values, e.g., from a private data source such as a data curator (e.g., as depicted in FIG. 2) or by retrieving it from a memory element (e.g., a hard drive) associated with the anonymizing computer. In some embodiments, the anonymizing computer can receive the private sequence of time-series data from a database.

In some embodiments, the anonymizing computer can additionally determine the length n of the private sequence of time-series data, e.g., by iterating through the private sequence of time-series data and counting the number of time-series data values stored therein. This length n can be used to perform a variety of steps depicted in FIG. 7. For example, the anonymizing computer can use the length n to initialize the anonymized sequence of time-series data at step 708, e.g., by generating an anonymized sequence of time-series data that is the same length as the private sequence of time-series data.

At step 704, the anonymizing computer can determine a matrix profile

$$M {P}_{m}^{T T}$$

and a matrix profile index

$${MPI}_{m}^{T T}$$

based on the private sequence of time-series data. The anonymizing computer can determine the matrix profile and matrix profile index by performing a self-join on the private sequence of time-series data. Any appropriate self-join or other matrix profile methods can be used for this purpose, such as the SCAMP method [49]. In some embodiments, the matrix profile can comprise a z-normalized matrix profile, e.g., the distances between each subsequence and its nearest neighbor subsequence in the matrix profile can comprise z-normalized Euclidean distances. The anonymizing computer can determine the matrix profile and the matrix profile index based on a subsequence length m, which may comprise a hyperparameter or another input to the anonymization method depicted in FIG. 7.

At step 706, the anonymizing computer can determine one or more private subsequence complexity values. The anonymizing computer can store the one or more private subsequence complexity values in a vector Cₘ. In some embodiments, the private sequence of time-series data can comprise one or more private subsequences, e.g., subsequences of the private sequence of time-series data of length m. The one or more private subsequence complexity values can correspond to these one or more private subsequences. As such, a data element Cₘ[i] in vector Cₘ can store the private subsequence complexity value corresponding to private subsequence T_{i,m}.

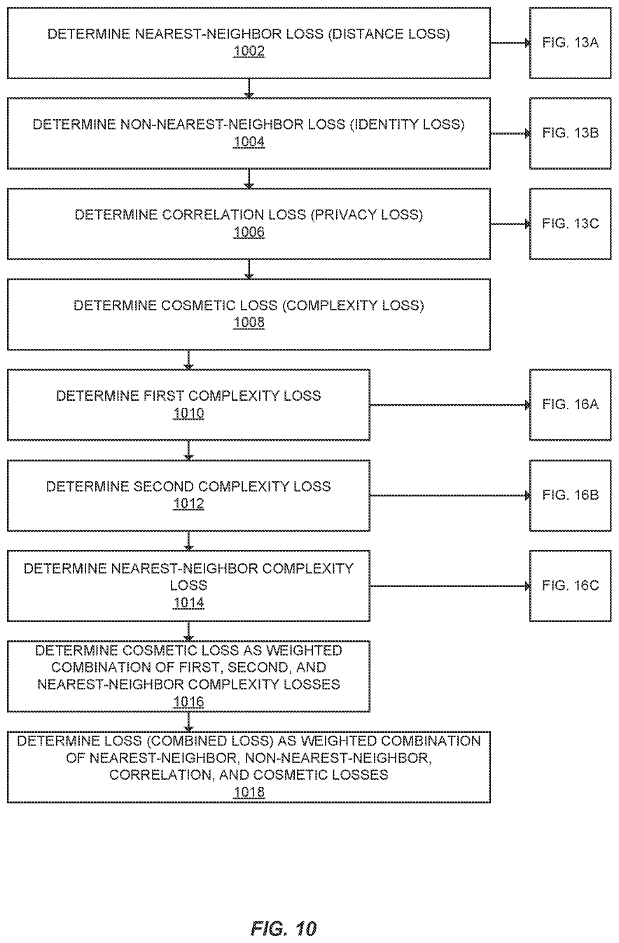

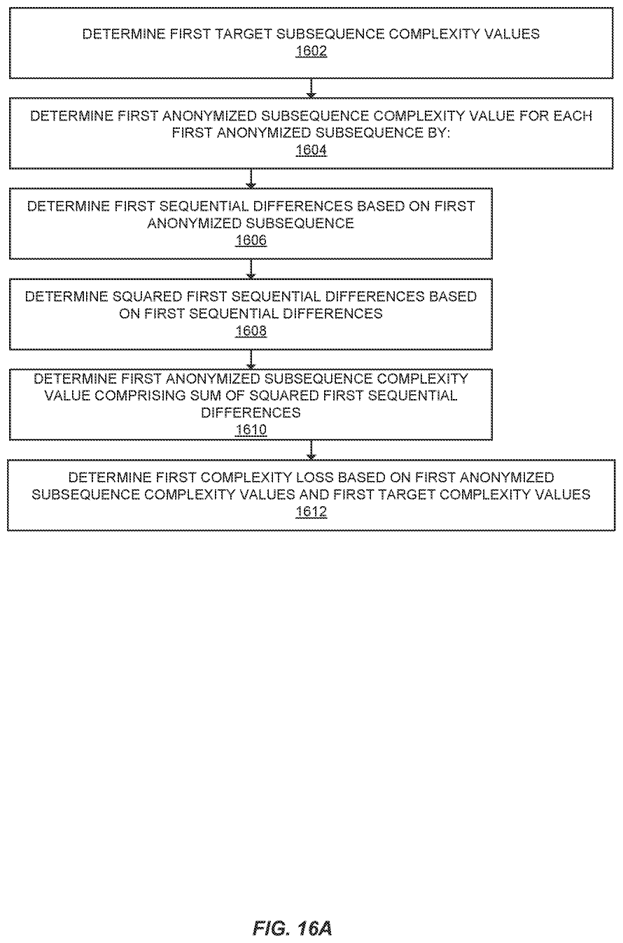

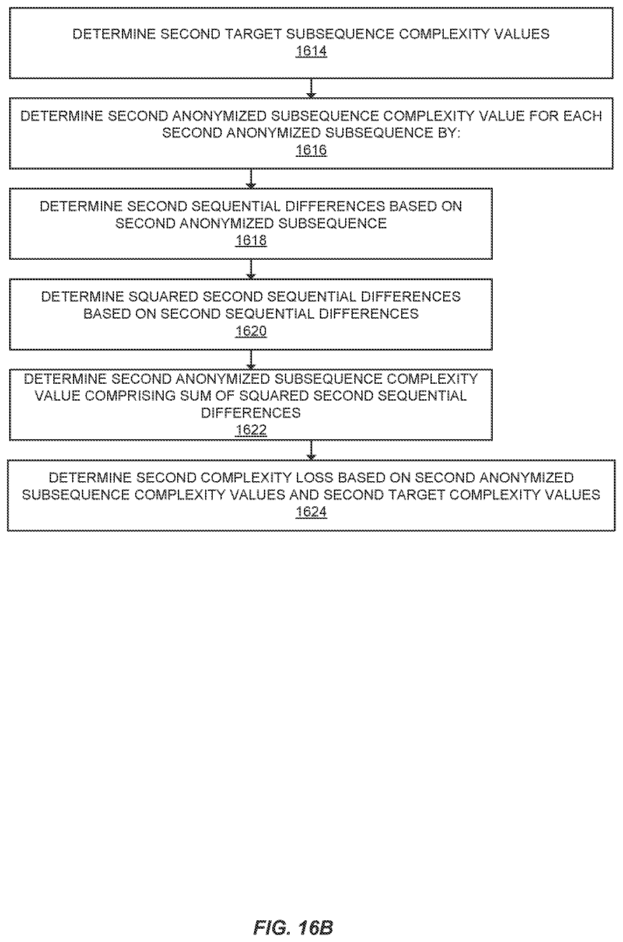

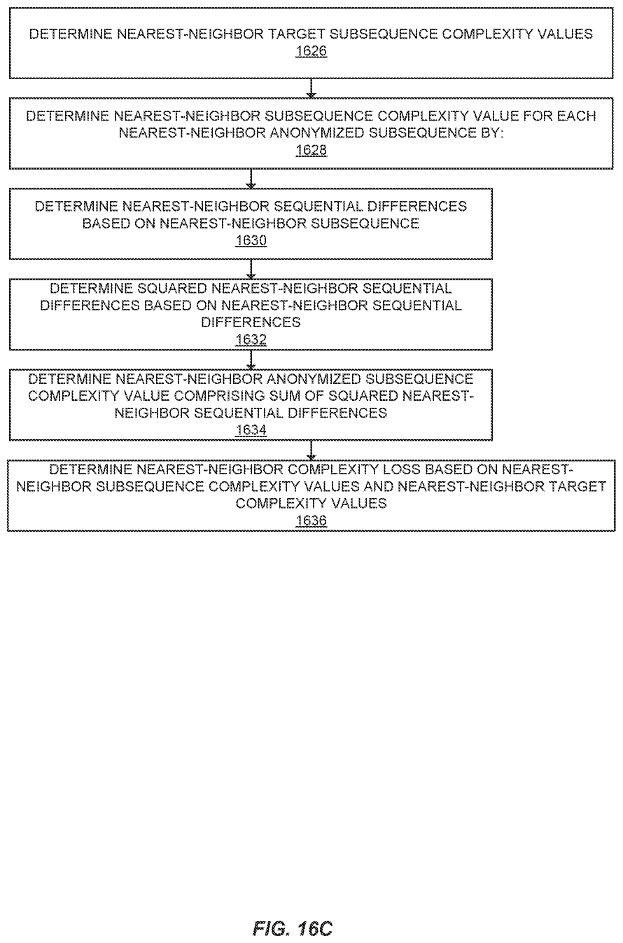

The one or more private subsequence complexity values can later be used to determine a cosmetic loss, e.g., as described below with reference to FIGS. 10 and 16A-16C. In more detail, the one or more private subsequence complexity values may be used to determine a first complexity loss, a second complexity loss, and a nearest-neighbor complexity loss, and in some embodiments, the cosmetic loss may comprise a weighted combination of the first complexity loss, the second complexity loss, and the nearest-neighbor complexity loss. As such, it may be possible for the anonymizing computer to defer the determination of the one or more private subsequence complexity values, e.g., the anonymizing computer can determine the one or more private subsequence complexity values when determining the cosmetic loss, rather than prior to the iterative process as described above.

The concept of time-series complexity and time-series complexity values is illustrated by FIG. 8. The complexity of a sequence or subsequence of time-series data generally relates to the frequency, amplitude, and general variability of that sequence or subsequence. The complexity of a sequence or subsequence of time-series data can be proportional to the length of that time-series after it is “stretched flat”. After such “stretching,” a more complex sequence or subsequence is longer than a less complex sequence or subsequence of time-series data.

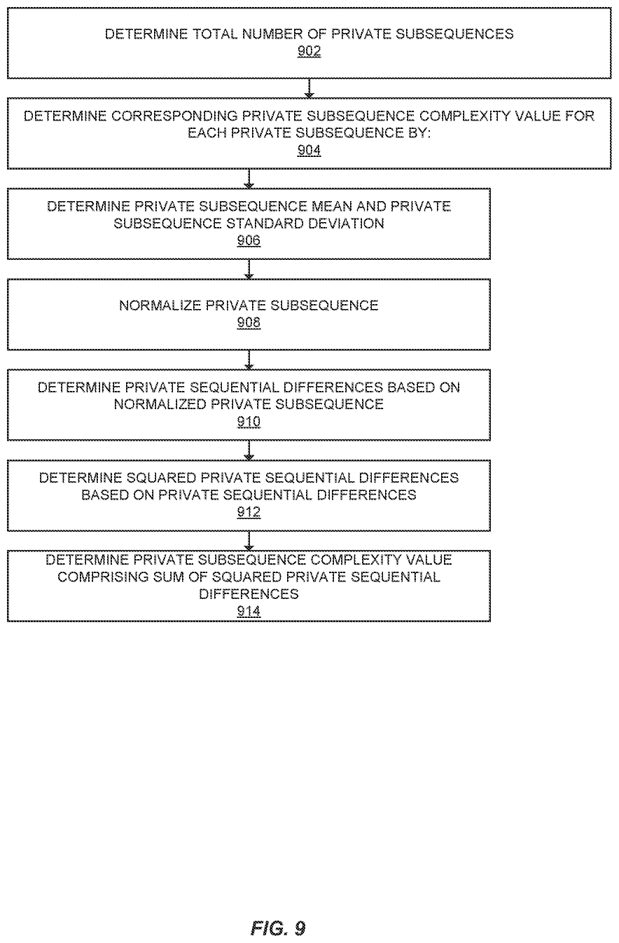

An exemplary series of steps for determining the one or more private subsequence complexity values is described in more detail with reference to FIG. 9. At step 902, the anonymizing computer can determine the total number of private subsequences in the private sequence of time-series data. Determining the total number of private subsequences may enable the anonymizing computer to iterate through the private sequence of time-series data, as well as allocate memory or otherwise initialize a data structure used to store the one or more private subsequence complexity values, e.g., the vector Cₘ as described above. In some embodiments, the anonymizing computer can determine the total number of private subsequences of time-series data using the formula total=n−m+1, where n is the length of the private sequence of time-series data, and m is the subsequence length.

At step 904, the anonymizing computer can determine, for each private subsequence of the one or more private subsequences, a corresponding private subsequence complexity value, thereby determining the one or more private subsequence complexity values. The process for determining a single private subsequence complexity value for a particular private subsequence T_{i,m} is described below with reference to steps 906-914. By repeating these steps for each private subsequence of the one or more private subsequences, the anonymizing computer can determine the one or more private subsequence complexity values.

At step 906, the anonymizing computer can determine a private subsequence mean μ and a private subsequence standard deviation o based on a private subsequence. The computer system can use any appropriate mean determination and standard deviation determination methods or formula to determine the private subsequence mean and the private subsequence standard deviation.

At step 908, the anonymizing computer can normalize the private subsequence based on the private subsequence mean and the private subsequence standard deviation. This normalization process can comprise a form of z-normalization in which the anonymizing computer uses a formula such as

$${T}_{i , m , norm} = \frac{{T}_{i , m} - μ}{σ}$$

to normalize the private subsequence. Expressed in other words, the anonymizing computer can subtract the private subsequence mean from the private subsequence, then scale (e.g., divide) the subtracted private subsequence based on the private subsequence standard deviation, thereby producing a normalized private subsequence. In some embodiments, the anonymizing computer can compare the private subsequence standard deviation to a private subsequence standard deviation threshold, and can scale the subtracted private subsequence based on this comparison. For example, if the private subsequence standard deviation σ>10⁻⁶, the anonymizing computer can divide the subtracted private subsequence by the private subsequence standard deviation to produce the normalized private subsequence. Otherwise, the anonymizing computer can use the subtracted private subsequence as the normalized private subsequence.

At step 910, the anonymizing computer can determine one or more private sequential differences T_{diff} based on the normalized private subsequence. Each private sequential difference of the one or more private sequential differences can comprise a difference between a normalized private subsequence time-series data value and a sequential normalized private subsequence time-series data value from the normalized private subsequence, e.g., T_{diff}[i]=T_{i,m,norm}[i+1]−T_{i,m,norm}[i].

At step 912, the anonymizing computer can determine one or more squared private sequential differences based on the private sequential differences, e.g., by squaring each private sequential difference of the one or more private sequential differences, e.g., T_{diff}[i]².

At step 914, the anonymizing computer can determine a sum of the one or more squared private sequential differences. The private subsequence complexity value can comprise the sum of these one or more squared private sequential differences, e.g., cₘ[i]=ΣT_{diff}[j]². Step 904 (and thereby steps 906-914) can be repeated for each private subsequence of the one or more private subsequence, thereby determining one or more private subsequence complexity values corresponding to the one or more private subsequences. As described above, these private subsequence complexity values can later be used in the determination of a cosmetic loss. As such, in some cases it may be preferable to determine the one or more private subsequence complexity values during the determination of the cosmetic loss. However, as the cosmetic loss can be determined during each round of the iterative process, determining the one or more private subsequence complexity values in this way may involve redundant computation. As such, it may be preferable to determine the one or more private subsequence complexity values before the iterative process, as described above.

Referring back to FIG. 7, at step 708, the anonymizing computer can initialize an anonymized sequence of time-series data \hat{T} comprising one or more anonymized sequence of time-series data values. In some embodiments, a length of the anonymized sequence of time-series data can be equal to the length of the private sequence of time-series data (which could be determined by the anonymizing computer in step 702 as described above). In some embodiments, the anonymizing computer can initialize the anonymized sequence of time-series data by generating one or more random values, and the one or more anonymized time-series data values can comprise the one or more random values. The anonymizing computer can initialize the anonymized sequence of time-series data values as a Gaussian noise vector, i.e., the anonymizing computer can sample the one or more random values from a standard normal distribution.

At step 710, the anonymizing computer can then perform an iterative process to update (e.g., optimize) the anonymized sequence of time-series data. This iterative process can comprise steps 710-720 in FIG. 7, and can be repeated until a terminating condition has been met. In general, in each round of the iterative process, the anonymizing computer can sample batches of time-series data. Each batch can comprise one or more subsequences of time-series data. These batches can be used to determine a loss [symbol] , which can be used to update the anonymized sequence of time-series data.

In some embodiments, the loss [symbol] may comprise a combined loss comprising a weighted combination of a plurality of losses, which can include a privacy loss [symbol] _{privacy} (which may also be referred to as a “correlation loss”), a distance loss [symbol] _{distance} (which may also be referred to as a “nearest-neighbor loss”), an identity loss [symbol] _{identity} (which may also be referred to as a “non-nearest-neighbor loss”), and a cosmetic loss [symbol] _{cosmetic} (which may also be referred to as a “complexity loss”). In some embodiments, a utility loss [symbol] _{utility} may comprise a weighted combination of the distance loss and the identity loss. Likewise, in some embodiments, the cosmetic loss may comprise a weighted combination of a first complexity loss, a second complexity loss, and a nearest neighbor complexity losses. One or more of these losses may correspond to the criteria or conditions described above. For example, the privacy loss may correspond to the privacy-preserving condition, while the utility loss may correspond to the utility-preserving condition.

Based on the loss, the anonymizing computer can update the anonymized sequence of time-series data using techniques such as mini-batch stochastic gradient descent. This iterative process of sampling batches, determining losses, and updating the anonymized sequence of time-series data can be repeated with the goal of progressively reducing the loss until a terminating condition has been met.

In more detail, at step 712, the anonymizing computer can sample a batch of anonymized subsequences comprising one or more anonymized subsequences from the anonymized sequence of time-series data. The anonymizing computer can sample the batch of anonymized subsequences randomly and without replacement. In some embodiments, the batch of anonymized subsequences can comprise a first batch of anonymized subsequences, in order to differentiate the first batch of anonymized subsequences from a second batch of anonymized subsequences described in more detail below. In some embodiments, the anonymizing computer can z-normalize the batch of anonymized sequences after sampling the batch of anonymized subsequences from the anonymized sequence of time-series data. The batch of anonymized subsequences can be later used to determine a variety of losses, such as a privacy loss, as described in more detail below.

Likewise, at step 712, the anonymizing computer can determine a batch of anonymized subsequence indicators corresponding to the batch of anonymized subsequences. The “anonymized subsequence indicators” are indicators that indicate the anonymized subsequences. The indicators themselves are not anonymized. The batch of anonymized subsequence indicators can comprise one or more anonymized subsequence indicators. In some embodiments, the batch of anonymized subsequence indicators can comprise a first batch of anonymized subsequence indicators corresponding to the first batch of anonymized subsequences. The (first) batch of anonymized subsequence indicators may be stored in, or represented by a vector I. In some embodiments, the (first) batch of anonymized subsequence indicators can be used to sample the (first) batch of anonymized subsequences. For example, each anonymized subsequence indicator can be used to identify the “starting point” of an anonymized subsequence of length m in the anonymized sequence of time-series data. In some embodiments, the anonymizing computer can determine the batch of anonymized subsequence indicators by randomly sampling (and sampling without replacement) n_{batch} times (where n_{batch} is a hyperparameter comprising the number of anonymized subsequences in the batch of anonymized subsequences) from an interval of integers [0, . . . , n−m](where n is the length of the anonymized sequence of time-series data).

In some embodiments, at step 712, the anonymizing computer can sample a second batch of anonymized subsequences comprising one or more second anonymized subsequences from the anonymized sequence of time-series data. Like the first batch of anonymized subsequences described above, the second batch of anonymized subsequences can be sampled randomly and without replacement. In some embodiments, the anonymizing computer can z-normalize the second batch of anonymized subsequences after sampling the second batch of anonymized subsequences from the anonymized sequence of time-series data. In some embodiments, the second batch of anonymized subsequences can be sampled such that the second batch of anonymized subsequences are different from the first batch of anonymized subsequences, e.g., no second anonymized subsequence from the second batch of anonymized subsequences is the same as a corresponding first anonymized subsequence from the first batch of anonymized subsequences. The second batch of anonymized subsequences can later be used to determine a variety of losses, such as identity loss (also referred to as a “non-nearest-neighbor loss”) as described below.

Likewise, the anonymizing computer can determine a second batch of anonymized subsequence indicators corresponding to the second batch of anonymized subsequences. The second batch of anonymized subsequence indicators can comprise one or more second anonymized subsequence indicators. The second batch of anonymized subsequence indicators may be stored in or represented by a vector K. In some embodiments, the second batch of anonymized subsequence indicators can be used to sample the second batch of anonymized subsequences. For example, each second anonymized subsequence indicator can be used to identify the starting point of a second anonymized subsequence of subsequence length m in the anonymized sequence of time-series data. In some embodiments, the anonymizing computer can determine the batch of anonymized subsequence indicators by sampling randomly (and sampling without replacement) a second anonymized subsequence indicator k from the interval of integers [0, . . . , n−m] for each first anonymized subsequence indicator i in the first batch of anonymized subsequence indicators I. The anonymizing computer can evaluate the second batch of anonymized subsequence indicators and resample second anonymized subsequence indicators if any second anonymized subsequence indicators is identical to a corresponding first anonymized subsequence indicator.

In some embodiments, at step 712, the anonymizing computer can additionally identify a batch of target subsequences T_{i,m} using the batch of anonymized subsequence indicators I and the private sequence of time-series data T. The batch of target subsequences can comprise one or more private subsequences from the private sequence of time-series data, and can each be of a predetermined subsequence length (e.g., m, as described above). Each private subsequence of the batch of target subsequences can generally correspond to a (first) anonymized subsequence from the (first) batch of anonymized subsequences. In some embodiments, the anonymizing computer can z-normalize each private subsequence of the batch of target subsequences after extracting the batch of private subsequences from the private sequence of time-series data. As described below, the batch of target subsequences can later be used to determine the correlation loss (also referred to as the privacy loss) by, e.g., determining the mean of the Pearson correlation between each (first) anonymized subsequence of the (first) batch of anonymized subsequences and a corresponding private subsequence of the batch of target subsequences.

At step 714, the anonymizing computer can determine a batch of nearest-neighbor subsequences using the anonymized sequence of time-series data, the matrix profile index, and the (first) batch of anonymized subsequence indicators. The batch of nearest-neighbor subsequences can comprise one or more nearest-neighbor subsequences. The batch of nearest-neighbor subsequences can comprise subsequences that are theoretically or expectedly the nearest-neighbors of the (first) batch of anonymized subsequences based on the nearest-neighbor indicators provided by the matrix profile index. As described further below, the batch of nearest-neighbor subsequences can later be used to calculate losses such as the utility loss, e.g., by determining the distances between the batch of nearest-neighbor subsequences and the (first) batch of anonymized subsequences and comparing it to the expected nearest-neighbor distances given by the matrix profile.

In some embodiments, the anonymizing computer can first determine a batch of nearest-neighbor indicators using the matrix profile index

$${MPI}_{m}^{T T}$$

and the (first) batch of anonymized subsequence indicators I. The batch of nearest-neighbor indicators can comprise one or more nearest-neighbor indicators. In some embodiments, the batch of nearest-neighbor indicators can be represented or stored in a vector J. In more detail, the anonymizing computer can index the matrix profile

$${MPI}_{m}^{T T}$$

using the (first) batch of anonymized subsequence indicators I to determine the batch of nearest-neighbor indicators J, i.e.,

$$J = {MPI}_{m}^{T T} [ I ] .$$

Here, square brackets enclosing an index vector are used to denote the operation of extracting elements from the vector preceding the left bracket

$${MPI}_{m}^{T T}$$

using the index vector enclosed in the brackets I.

The anonymizing computer can then determine the batch of nearest-neighbor subsequences \hat{T}_{J,m} using the batch of nearest-neighbor indicators and the anonymize sequence of time-series data \hat{T}, e.g., by acquiring a batch of n_{batch} subsequences of length m from the anonymized sequence of time-series data \hat{T} using the batch of nearest-neighbor indicators J. In some embodiments, the anonymizing computer can z-normalize the one or more nearest-neighbor subsequences in the batch of nearest-neighbor subsequences after acquiring the batch of nearest-neighbor subsequences.

At step 716, the anonymizing computer can determine a loss [symbol] based on the batch of anonymized subsequences, the batch of anonymized subsequence indicators, the private sequence of time-series data, the matrix profile, and the matrix profile index. In some embodiments, the loss may comprise a combined loss, comprising a weighted combination of a plurality of losses. As such, the anonymizing computer can determine the loss [symbol] by determining each loss of the plurality of losses and then determining a weighted combination of the plurality of losses. The combined loss may be formulated such that the solution of argmin_{\hat{T}} [symbol] (T, \hat{T}) satisfies some of the conditions described above (e.g., the privacy-preserving condition, the utility-preserving condition, and the cosmetic condition).

One (unweighted, or equally weighted) formulation of the loss is [symbol] = [symbol] _{privacy}+ [symbol] _{utility}+ [symbol] _{cosmetic}, e.g., a sum of the privacy loss [symbol] _{privacy} (also referred to as the “correlation loss”), the utility loss [symbol] _{utility}, and the cosmetic loss [symbol] _{cosmetic} (also referred to as the “complexity loss”). In some embodiments, the utility loss may itself comprise a combination of a distance loss [symbol] _{distance} (also referred to as a “nearest-neighbor loss”) and an identity loss [symbol] _{identity} (also referred to as a “non-nearest-neighbor loss”), i.e., [symbol] _{utility}=L_{distance}+ [symbol] _{identity}. Some of the plurality of losses, particularly losses determined using the matrix profile, may be referred to as “matrix profile losses”. For example, the distance loss may be determined using the matrix profile and may comprise a matrix profile loss. In some embodiments, the cosmetic loss may comprise a weighted combination of a plurality of cosmetic losses, which may include a first cosmetic loss [symbol] _{c1} corresponding to the first batch of anonymized subsequences, a second cosmetic loss [symbol] _{c2} corresponding to the second batch of anonymized subsequences, and a nearest-neighbor cosmetic loss [symbol] _{CNN} corresponding to the batch of nearest-neighbor subsequences, i.e., [symbol] _{cosmetic}=+ [symbol] _{c1}+ [symbol] _{c2}+ [symbol] _{cnn}. If the loss comprises a weighted combination of the plurality of losses, the iterative process can additionally comprise the anonymizing computer determining, e.g., the nearest-neighbor loss, the correlation loss, and the cosmetic losses.

Another formulation of the loss is [symbol] = [symbol] _{privacy}+α [symbol] _{distance}+β [symbol] _{identity}+γ [symbol] _{cosmetic}, where α, β, and γ are weighting hyperparameters used to weight each loss relative to the privacy loss. In some embodiments, hyperparameters such as α=1, β=2, and γ=1 can be used to calculate the loss, however it should be understood that any appropriate values of α, β, and γ can be used to weight the plurality of losses.

A process for determining the plurality of losses is described below with reference to FIGS. 10, 13A-13C, and FIGS. 16A-16C. It should be understood that the combined loss can comprise a combination of some or all of the losses described above, as well as other losses. As such, some or all of the loss determination steps described below with reference to these figures may be optional.

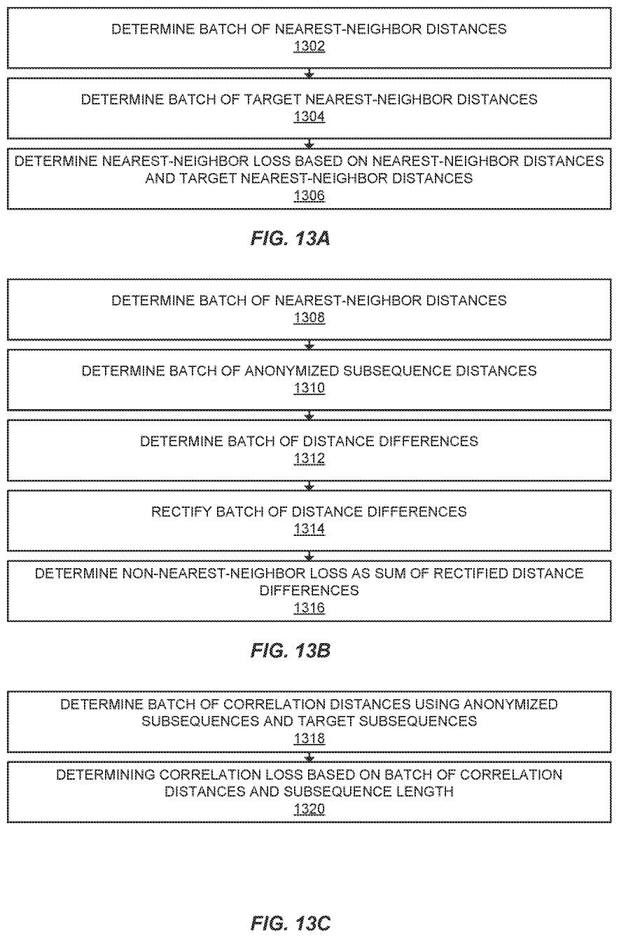

Referring to FIG. 10, at step 1002, the anonymizing computer can determine the nearest-neighbor loss, also referred to as the distance loss. An exemplary process for determining the nearest-neighbor loss is described below with reference to FIG. 13A. In general, the nearest-neighbor loss relates the expected difference between each (first) anonymized subsequence of the (first) batch of anonymized subsequences and their corresponding nearest-neighbor subsequence from the batch of nearest-neighbor subsequences and the actual difference between those subsequences. The nearest-neighbor loss may relate to the utility of the anonymized sequence of time-series data, and may therefore be a component of the utility loss, as described above. If the anonymized sequence of time-series data preserves the matrix profile of the private sequence of time-series data, then the distance between each anonymized subsequence and its supposed nearest-neighbor subsequence should be similar to the distance indicated by the matrix profile. As stated above, the nearest-neighbor loss can comprise a matrix profile loss.

Generally, a nearest-neighbor loss (or distance loss) corresponding to a (first) anonymized subsequence can be defined by the formula [symbol] _{distance}=(Dist(T_{i,m}, T_{j,m})−Dist(\hat{T}_{i,m},\hat{T}_{j,m}))², which comprises the square of the difference in the z-normalized Euclidean distance (Dist(⋅,⋅)) between a private subsequence of time-series data T_{i,m} and its nearest-neighbor T_{j,m} (which can be derived from the matrix profile) and the distance between an anonymized sequence of time-series data \hat{T}_{i,m} and its supposed nearest-neighbor \hat{T}_{j,m}. The distance loss for an entire (first) batch of anonymized subsequences can comprise a mean squared error of distance losses corresponding to each (first) anonymized subsequence in the (first) batch of anonymized subsequences.

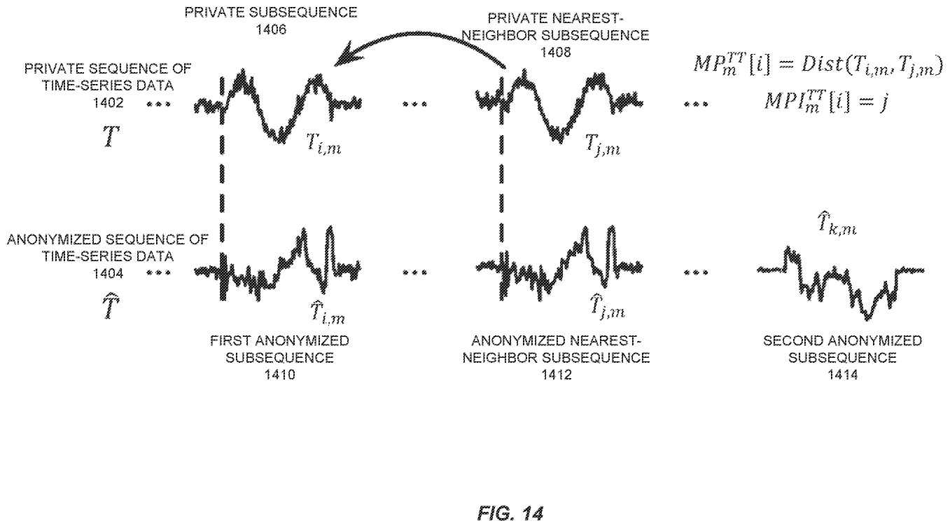

Minimizing the distance loss (using, e.g., mini-batch stochastic gradient descent) can result in an anonymized sequence of time-series data that has a matrix profile similar to the private sequence of time-series data, thereby partially satisfying the utility-preserving condition. As shown in FIG. 14, the distance loss for an individual first anonymized subsequence (e.g., first anonymized subsequence 1410) can be minimized when the distance between that first anonymized subsequences and a corresponding anonymized nearest-neighbor subsequence (e.g., anonymized nearest-neighbor subsequence 1412) is similar to the difference between a private subsequence of time-series data (e.g., private subsequence 1406) and it's corresponding nearest-neighbor subsequence (e.g., private nearest-neighbor subsequence 1408).

An exemplary method of determining the nearest-neighbor loss is described with reference to FIG. 13A. At step 1302, the anonymizing computer can determine a batch of nearest-neighbor distances comprising one or more nearest-neighbor distances based on the batch of anonymized subsequences and the batch of nearest-neighbor subsequences. The batch of nearest-neighbor distances can comprise z-normalized Euclidean distances. The anonymizing computer can use any appropriate method or formulation to determine the batch of nearest-neighbor distances, such as the standard formula for calculating Euclidean distance between the z-normalized anonymized subsequences and the z-normalized batch of nearest-neighbor subsequences.

At step 1304, the anonymizing computer can determine a batch of target nearest neighbor distances. The batch of target nearest-neighbor distances can comprise one or more target nearest-neighbor distances. The anonymizing computer can determine that batch of target nearest-neighbor distances using the (first) batch of anonymized subsequence indicators and the matrix profile, e.g., by indexing the matrix profile using the (first) batch of anonymized subsequence indicators, i.e.,

$$M {P}_{m}^{T T} [ I ] .$$

In some embodiments, the batch of target nearest-neighbor distances can comprise z-normalized Euclidean distances.

At step 1306, the anonymizing computer can determine the nearest-neighbor loss based on the batch of nearest-neighbor distances and the batch of target nearest-neighbor distances, e.g., the anonymizing computer can use the formula [symbol] _{distance}=(Dist(T_{i,m}, T_{j,m})−Dist(\hat{T}_{i,m}, \hat{T}_{j,m}))² to calculate one or more nearest-neighbor losses corresponding to each (first) anonymized subsequence in the (first) batch of anonymized subsequences using the batch of nearest-neighbor distances and the batch of target nearest-neighbor distances. The anonymizing computer can then determine a mean squared error of these one or more nearest-neighbor losses, and the nearest-neighbor loss can comprise this mean squared error.

Referring back to FIG. 10, at step 1004, the anonymizing computer can determine the non-nearest-neighbor loss, also referred to as the identity loss. The anonymizing computer can determine the non-nearest-neighbor loss based on the first batch of anonymized subsequences, the second batch of anonymized subsequences, and the batch of nearest-neighbor subsequences. An exemplary process for determining the non-nearest-neighbor loss is described below with reference to FIG. 13B.

In general, the non-nearest-neighbor loss relates to differences between the first batch of anonymized subsequences and the second batch of anonymized sequences. The non-nearest-neighbor loss may relate to the utility of the anonymized sequence of time-series data, and may be a component of the utility loss. The non-nearest neighbor loss can comprise a matrix profile loss. If the anonymized sequence of time-series data preserves the matrix profile of the private sequence of time-series data, then the difference between a first anonymized subsequence and a random anonymized subsequence (e.g., a second anonymized subsequence) can be greater than that distance between the first anonymized subsequence and its supposed nearest-neighbor subsequence, as determined by the matrix profile index.

In other words, if the nearest neighbor of T_{i,m} is T_{j,m}, then Dist(\hat{T}_{i,m}, \hat{T}_{j,m}) is preferably smaller than Dist(\hat{T}_{i,m}, \hat{T}_{k,m}) for any k∈{0, . . . , n−m+1}\{i,j}. To enforce such a relationship, the nearest-neighbor loss [symbol] _{identity} for a given (first) anonymized subsequence can be defined using the formula: [symbol] _{identity}=ReLU(Dist(\hat{T}_{i,m}, \hat{T}_{j,m})−Dist(\hat{T}_{i,m}, \hat{T}_{k,m})), where ReLU is a rectified linear unit function that returns the value of its argument if the value of the argument is greater than or equal to zero, and returns zero otherwise. As described above, the term Dist(\hat{T}_{i,m}, \hat{T}_{j,m}) computes the distance between a supposed nearest-neighbor pair of subsequences and the term Dist(\hat{T}_{i,m}, \hat{T}_{k,m}) computes the distance between a supposed non-nearest-neighbor pair of subsequences. To preserve the matrix profile from the private sequence of time-series data, Dist(\hat{T}_{i,m}, \hat{T}_{j,m}) is preferably less than Dist(\hat{T}_{i,m}, \hat{T}_{k,m}). The formulation above can result in non-zero values if such a relationship is violated. As shown in FIG. 14, the non-nearest-neighbor loss corresponding to a particular first anonymized subsequence (such as first anonymized subsequence 1410) is minimized when the first anonymized subsequence is more similar to an anonymized nearest-neighbor subsequence (such as anonymized nearest-neighbor subsequence 1412) than a second anonymized subsequence (e.g., second anonymized subsequence 1414).

Referring to FIG. 13B, at step 1308, the anonymizing computer can determine a batch of nearest-neighbor distances based on the first batch of anonymized subsequences and the batch of nearest-neighbor indicators. The batch of nearest-neighbor distances can comprise one or more nearest-neighbor distances. The anonymizing computer can use any of the methods described above, e.g., with reference to step 1302 of FIG. 13A to determine the batch of nearest-neighbor distances. Alternatively, the anonymizing computer can determine the nearest-neighbor distances at step 1302, store the nearest-neighbor distances, then retrieve them at step 1308, eliminating the need to determine the batch of nearest-neighbor distances twice. The batch of nearest-neighbor distances can comprise z-normalized Euclidean distances.

At step 1310, the anonymizing computer can determine a batch of anonymized subsequence distances using the first batch of anonymized subsequences and the second batch of anonymized subsequences. The batch of anonymized subsequence distances can comprise one or more anonymized subsequence distances and can comprise z-normalized Euclidean distances. The anonymization computer can use any appropriate method or formulation to determine the batch of nearest-neighbor distances, such as the standard formula for calculating Euclidean distances between the z-normalized batch of first anonymized subsequences and the z-normalized batch of nearest-neighbor subsequences.

At step 1312, the anonymizing computer can determine a batch of distance differences based on the batch of nearest-neighbor distances and the batch of anonymized subsequence differences. The batch of distance differences can comprise one or more distance differences. In some embodiments, the anonymizing computer can determine the batch of distance differences by subtracting each nearest-neighbor distance of the one or more nearest-neighbor distances from a corresponding anonymized subsequence distance of the one or more anonymized subsequence differences, thereby determining the one or more distance differences. The anonymizing computer can determine the nearest-neighbor loss based on this batch of distance differences, e.g., by performing steps 1314 and 1316.

At step 1314, the anonymizing computer can rectify the batch of distance differences using, e.g., a rectified linear unit (ReLU), thereby producing a rectified batch of distance differences comprising one or more rectified distance differences. Subsequently, at step 1316, the anonymizing computer can determine a sum of the rectified batch of distance differences. The nearest-neighbor loss can comprise this sum of the rectified batch of distance differences.

Referring back to FIG. 10, at step 1006, the anonymizing computer can determine a correlation loss, also referred to as a privacy loss. An exemplary process for determining the correlation loss is described below with reference to FIG. 13C. In general, the correlation loss relates to the correlation between each (first) anonymized subsequence in the first batch of anonymized subsequences and a corresponding private subsequence in the private sequence of time-series data (which may be referred to as a “target subsequence”, e.g., one of the batch of target subsequences determined at step 712 of FIG. 7). If each anonymized subsequence and its corresponding target subsequence are uncorrelated, then it may be difficult or impossible to determine any time-series data values from the private sequence of time-series data values given the anonymized sequence of time-series data values. As such, the correlation loss may be minimized when the (first) anonymized subsequences in the (first) batch of anonymized subsequences are uncorrelated with the private subsequences in the private sequence of time-series data.

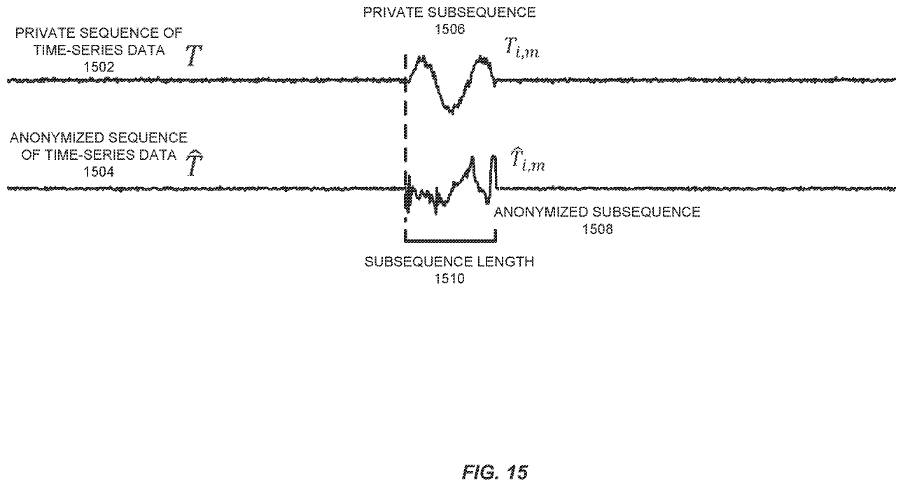

In some embodiments, the correlation loss (privacy loss) corresponding to a particular (first) subsequence of time-series data can be defined using the formula [symbol] _{privacy}=PearsonCorr(T_{i,m}, \hat{T}_{i,m})². As shown in FIG. 15, the privacy loss can be determined by evaluating the correlation between private subsequences of time-series data (such as private subsequence 1506) from the private sequence of time series data 1502 (e.g., private subsequences from the batch of target subsequence), and anonymized subsequences of time-series data (such as anonymized subsequence 108) from the anonymized sequence of time-series data 1504. The private subsequences of time-series data and corresponding anonymized subsequences of time-series data may have equal subsequence length m 1510 and may be defined by indicators i∈I, e.g., the (first) batch of anonymized subsequence indicators.

There are a variety of methods or procedures that can be used to determine the Pearson correlation between subsequences of time-series data. One such method is described below with reference to FIG. 13C. At step 1318, the anonymizing computer can determine a batch of correlation distances using the batch of anonymized subsequences and the batch of target subsequences. The batch of correlation distances can comprise one or more correlation distances. Each correlation distance of the one or more correlation distances can comprise a distance between an anonymized subsequence of the batch of anonymized subsequences and a corresponding target subsequence of the batch of target subsequences. The batch of correlation distances can comprise Euclidean distances or z-normalized Euclidean distances, and can be determined using any appropriate method for determining Euclidean distances or z-normalized Euclidean distances.

At step 1320, the anonymizing computer can determine the correlation loss based on the batch of correlation distances and a subsequence length. As described above, in some embodiments, the correlation loss can be equal to a squared Pearson correlation coefficient, which can correspond to a correlation between the batch of (first) anonymized subsequences and the batch of target subsequences. Using the relationship Dist(T_{i,m}, \hat{T}_{i,m})={square root over (2m(1−PearsonCorr(T_{i,m}, \hat{T}_{i,m})))}, the anonymizing computer can determine the correlation loss (corresponding to an individual (first) anonymized subsequence of the first batch of anonymized subsequences) based on the batch of correlation distances and the subsequence length m using the formula:

$${L}_{privacy} = {( 1 - \frac{D i s {t ( {T}_{i , m} , {\hat{T}}_{i , m} )}^{2}}{2 m} )}^{2} .$$

The anonymizing computer can perform this process for each (first) anonymized subsequence in the batch of (first) anonymized subsequences, then determine the aggregate correlation loss as the mean of the resulting losses. It should be understood however that the anonymizing computer can use any other appropriate method or formula to determine the correlation loss.

Referring back to FIG. 10, In some embodiments, in addition to the nearest-neighbor loss and the non-nearest neighbor loss described above, the plurality of losses can comprise an optional cosmetic loss [symbol] _{cosmettic} (also referred to as a complexity loss). The anonymizing computer can determine this cosmetic loss at step 1008. In some embodiments, the anonymizing computer can determine the cosmetic loss based on one or more private subsequence complexity values (e.g., determined at step 706 of FIG. 7), the first batch of anonymized subsequences, the first batch of anonymized subsequence indicators, the first batch of nearest-neighbor subsequences, and the first batch of nearest-neighbor subsequence indicators. In some embodiments, the anonymizing computer can additionally use the second batch of anonymized subsequences and the second batch of anonymized subsequence indicators to determine the cosmetic loss.

In some embodiments, the cosmetic loss may comprise a weighted combination of a first complexity loss [symbol] _{c1}, a second complexity loss [symbol] _{c2}, and a nearest-neighbor complexity loss [symbol] _{cnn}. In some embodiments, this weighted combination may be referred to as a “second weighted combination,” in order to distinguish it from the weighted combination used to determine the combined loss (which may be referred to as a “first weighted combination”). The anonymizing computer can determine these complexity losses in steps 1010-1014, then determine the cosmetic loss by combining these complexity losses at step 1016.

At step 1010, the anonymizing computer can determine the first complexity loss [symbol] _{c1} based on the first batch of anonymized subsequences, the first batch of anonymized subsequence indicators, and one or more private subsequence complexity values. The first complexity loss can correspond to the first batch of anonymized subsequences, and the one or more private subsequence complexity values can correspond to one or more private subsequences of the private subsequences of time-series data, which may have been determined by the anonymizing computer earlier, e.g., at step 706 of FIG. 7. An exemplary process of determining the first complexity loss is described below with reference to FIG. 16A. In general, the first complexity loss [symbol] _{c1} for a first anonymized subsequence of time-series data \hat{T}_{i,m} can be determined using the formula [symbol] _{c1}=(Complexity(T_{i,m})−Complexity(\hat{T}_{i,m}))², where the Complexity(⋅) function compute the complexity of its input using, e.g., the methods introduced in [9]. Complexity(T_{i,m}) can comprise a corresponding target subsequence complexity value, which can be determined from the one or more private subsequence complexity values stored in vector Cₘ, as described above with reference to step 706 of FIG. 7.

In more detail, and with reference to FIG. 16A, at step 1602, the anonymizing computer can determine one or more first target subsequence complexity values using the one or more private subsequence complexity values Cₘ and the first batch of anonymized subsequence indicators I, e.g., by indexing Cₘ using I, i.e., Cₘ[I]. These one or more first target subsequence complexity values can correspond to the Complexity(T_{i,m}) term presented in the first complexity loss formula described above.

At step 1604, the anonymizing computer can determine a first anonymized subsequence complexity value for each first anonymized subsequence, thereby determining one or more first anonymized subsequence complexity values. The anonymizing computer can determine each first anonymized subsequence complexity value by performing steps 1606-1610, as described below.

At step 1606, the anonymizing computer can determine one or more first sequential differences based on the first batch of anonymized subsequences. Each first sequential difference of the one or more first sequential differences can comprise a difference between a first anonymized subsequence time-series data value of the first anonymized subsequence and a sequential first anonymized time-series data value of the first anonymized subsequence, i.e., \hat{T}_{i,m,diff}[i]=\hat{T}_{i,m}[i+1]−\hat{T}_{i,m}[i]. The anonymizing computer can z-normalize the first anonymize sequence prior to determining the one or more first sequential differences, if necessary.

At step 1608, the anonymizing computer can determine one or more squared first sequential differences by squaring each first sequential difference of the one or more first sequential differences, i.e., \hat{T}_{i,m,diff}[i]².

At step 1610, the anonymizing computer can determine a sum of the one or more squared first sequential differences i.e., Complexity(\hat{T}_{i,m})=Σᵢ\hat{T}_{i,m,diff}[i]². The corresponding first anonymized subsequence complexity value can comprise this sum of the one or more squared first sequential differences. As described above, steps 1606-1610 generally correspond to a process for determining a first anonymized subsequence complexity value for a single first anonymized subsequence. As such, as described above, steps 1606-1610 can be performed for each first anonymized subsequence of the first batch of anonymized subsequences to determine one or more first anonymized subsequence complexity values.

At step 1612, the anonymizing computer can determine the first complexity loss [symbol] _{c1} based on the first anonymized subsequence complexity values and the first target complexity values. In some embodiments, the anonymizing computer can determine a first mean squared error between the one or more first anonymized subsequence complexity values Complexity(\hat{T}_{i,m}) and the one first target subsequence complexity values Complexity(T_{i,m}), and the first complexity loss [symbol] _{c1} can comprise the first mean squared error.

Referring back to FIG. 10, at step 1012, the anonymizing computer can determine the second complexity loss [symbol] _{c2} based on the second batch of anonymized subsequences, the second batch of anonymized subsequence indicators, and one or more private subsequence complexity values. The second complexity loss can correspond to the second batch of anonymized subsequences, and (as described above) the one or more private subsequence complexity values can correspond to one or more private subsequences of the private subsequences of time-series data. An exemplary process of determining the second complexity loss is described below with reference to FIG. 16B. In general, the second complexity loss [symbol] _{c2} or a second anonymized subsequence of time-series data \hat{T}_{k,m} can be determined using the formula [symbol] _{c2}=(Complexity(T_{k,m})−Complexity(\hat{T}_{k,m})². Complexity(T_{k,m}) can comprise a corresponding target subsequence complexity value, which can be determined from the one or more private subsequence complexity values stored in vector Cₘ, e.g., determined by the anonymizing computer in step 706 of the flowchart of FIG. 7.

In more detail, and with reference to FIG. 16B, at step 1612, the anonymizing computer can determine one or more second target subsequence complexity values using the one or more private subsequence complexity values Cₘ and the second batch of anonymized subsequence indicators K, e.g., by indexing Cₘ using K, i.e., Cₘ[K]. These one or more second target subsequence complexity values can correspond to the Complexity(T_{k,m}) term presented in the second complexity loss formula described above.

At step 1616, the anonymizing computer can determine a second anonymized subsequence complexity value for each second anonymized subsequence, thereby determining one or more second anonymized subsequence complexity values. The anonymizing computer can determine each second anonymized subsequence complexity value by performing steps 1618-1622.

At step 1618, the anonymizing computer can determine one or more second sequential differences based on the second batch of anonymized subsequences. Each second sequential difference of the one or more second sequential differences can comprise a difference between a second anonymized subsequence time-series data value of the second anonymized subsequence and a sequential second anonymized time-series data value of the second anonymized subsequence, i.e., \hat{T}_{k,m,diff}[i]=\hat{T}_{k,m}[i+1]−T_{k,m}[i]. The anonymizing computer can z-normalize the second anonymize sequence prior to determining the one or more second sequential differences, if necessary.

At step 1620, the anonymizing computer can determine one or more squared second sequential differences by squaring each second sequential difference of the one or more second sequential differences, i.e., \hat{T}_{k,m,diff}[i]².

At step 1622, the anonymizing computer can determine a sum of the one or more squared second sequential differences i.e., Complexity(\hat{T}_{k,m})=Σᵢ\hat{T}_{k,m,diff}[i]². The corresponding second anonymized subsequence complexity value can comprise this sum of the one or more squared second sequential differences. As described above, steps 1618-1622 generally correspond to a process for determining a second anonymized subsequence complexity value for a single second anonymized subsequence. As such, steps 1618-1622 can be performed for each second anonymized subsequence of the second batch of anonymized subsequences to determine one or more second anonymized subsequence complexity values.

At step 1624, the anonymizing computer can determine the second complexity loss [symbol] _{c2} based on the second anonymized subsequence complexity values and the second target complexity values. In some embodiments, the anonymizing computer can determine a second mean squared error between the one or more second anonymized subsequence complexity values Complexity(\hat{T}_{k,m}) and the one second target subsequence complexity values Complexity(\hat{T}_{k,m}), and the second complexity loss [symbol] _{c2} can comprise the second mean squared error.

Referring back to FIG. 10, at step 1014, the anonymizing computer can determine the nearest-neighbor complexity loss [symbol] _{cnn} based on the batch of nearest-neighbor subsequences, a batch of nearest-neighbor subsequence indicators, and one or more private subsequence complexity values. The nearest-neighbor complexity loss can correspond to the batch of nearest-neighbor subsequences, and (as described above) the one or more private subsequence complexity values can correspond to one or more private subsequences of the private subsequences of time-series data. An exemplary process of determining the nearest-neighbor complexity loss is described below with reference to FIG. 16C.

In general, the nearest-neighbor complexity loss [symbol] _{cnn} for a nearest-neighbor anonymized subsequence of time-series data \hat{T}_{j,m} can be determined using the formula [symbol] _{cnn}=(Complexity(T_{j,m})−Complexity(\hat{T}_{j,m}))². Complexity(T_{j,m}) can [symbol] comprise a corresponding target subsequence complexity value, which can be determined from the one or more private subsequence complexity values stored in vector Cₘ.

In more detail, and with reference to FIG. 16C, at step 1626, the anonymizing computer can determine one or more target nearest-neighbor subsequence complexity values using the one or more private subsequence complexity values Cₘ and the batch of nearest-neighbor subsequence indicators J, e.g., by indexing Cₘ using J, i.e., Cₘ[J]. These one or more target nearest-neighbor subsequence complexity values can correspond to the Complexity(T_{j,m}) term presented in the nearest-neighbor complexity loss formula described above.

At step 1628, the anonymizing computer can determine a nearest-neighbor subsequence complexity value for each nearest-neighbor subsequence, thereby determining one or more nearest-neighbor subsequence complexity values. The anonymizing computer can determine each nearest-neighbor subsequence complexity value by performing steps 1630-1634.

At step 1630, the anonymizing computer can determine one or more nearest-neighbor sequential differences based on the batch of nearest-neighbor subsequences. Each nearest-neighbor sequential difference of the one or more nearest-neighbor sequential differences can comprise a difference between a nearest-neighbor subsequence time-series data value of the nearest-neighbor subsequence and a sequential nearest-neighbor time-series data value of the nearest-neighbor subsequence, i.e., \hat{T}_{j,m,diff}[i]=\hat{T}_{j,m}[i+1]−\hat{T}_{j,m}[i]. The anonymizing computer can z-normalize the nearest-neighbor sequence prior to determining the one or more nearest-neighbor sequential differences, if necessary.

At step 1632, the anonymizing computer can determine one or more squared nearest-neighbor sequential differences by squaring each nearest-neighbor sequential difference of the one or more nearest-neighbor sequential differences, i.e., \hat{T}_{j,m,diff}[i]².

At step 1634, the anonymizing computer can determine a sum of the one or more squared nearest-neighbor sequential differences i.e., Complexity(\hat{T}_{j,m})=Σᵢ\hat{T}_{j,m,diff}[i]². The corresponding nearest-neighbor subsequence complexity value can comprise this sum of the one or more squared nearest-neighbor sequential differences. As described above, steps 1630-1634 generally correspond to a process for determining a nearest-neighbor subsequence complexity value for a single nearest-neighbor subsequence. As such, as described above, steps 1630-1634 can be performed for each nearest-neighbor subsequence of the batch of nearest-neighbor subsequences to determine one or more nearest-neighbor subsequence complexity values.

At step 1636, the anonymizing computer can determine the nearest-neighbor complexity loss [symbol] _{cnn} based on the nearest-neighbor subsequence complexity values and the target nearest-neighbor complexity values. In some embodiments, the anonymizing computer can determine a nearest-neighbor mean squared error between the one or more nearest-neighbor subsequence complexity values Complexity(\hat{T}_{k,m}) and the one target nearest-neighbor subsequence complexity values Complexity(\hat{T}_{k,m}), and the nearest-neighbor complexity loss [symbol] _{cnn} can comprise the nearest-neighbor mean squared error.

Referring back to FIG. 10, at step 1016, the anonymizing computer can determine a weighted combination (sometimes referred to as a “second weighted combination”) of the first complexity loss, the second complexity loss, and the nearest-neighbor complexity loss. The cosmetic loss [symbol] _{cosmetic} can comprise this weighted combination. The anonymizing computer can use any appropriate weighting terms, which may comprise hyperparameters of anonymization methods according to embodiments. In some embodiments, the first complexity loss, the second complexity loss, and the nearest-neighbor complexity loss may be equally weighted.

At step 1018, having determined a plurality of losses, the anonymizing computer can determine the combined loss as a weighted combination of the plurality of losses. In some embodiments, this weighted combination (sometimes referred to as a “first weighted combination”) can comprise a weighted combination of the nearest-neighbor loss, the non-nearest neighbor loss, the correlation loss, and the cosmetic loss. The anonymizing computer can use a formula such as [symbol] = [symbol] _{privacy}+α [symbol] _{distance}+β [symbol] _{identity}+γ [symbol] _{cosmetic} to determine the combined loss [symbol] , where α, β, and γ can comprise weighting hyperparameters used to control the relative importance of each individual loss in the weighted combination of losses. In some embodiments, weighting hyperparameters such as α=1, β=2, and γ=1 can be used, however other weighting hyperparameters can also be used to determine the combined loss.

Referring back to FIG. 7, having determined the loss, at step 718, the anonymizing computer can update the anonymized sequence of time-series data based on the loss, completing an iteration of the iterative process. In some embodiments, updating the anonymized sequence of time-series data comprises updating the anonymized sequence of time-series data using mini-batch stochastic gradient descent. The anonymizing computer can determine a gradient of the loss with respect to batches of anonymized subsequences of time-series data, then determine a gradient update, which can be used to update the anonymized sequence of time-series data. The gradient update can correspond to a change in the anonymized sequence of time-series data that results in the greatest reduction (or expected greatest reduction) in the loss in subsequent iterations of the iterative process. In some embodiments, updating the anonymized sequence of time-series data can further comprise z-normalizing the anonymized sequence of time-series data after updating the anonymized sequence of time-series data using stochastic gradient descent. Optionally z-normalizing the anonymized sequence of time-series data in this manner can improve the convergence of the iterative process.

At step 720, the computer system can repeat the iterative process until a terminating condition has been met, e.g., by returning to step 710 and repeating steps 710-720 (e.g., by sampling new batches of anonymized subsequences and target subsequences at step 712 (which may be different than the batches of subsequences sampled in the current iteration), determining a new batch of nearest-neighbor subsequences at step 714, determining a loss at step 716, and updating the anonymized sequence of time-series data based on the loss at step 718.

In some embodiments, the terminating condition may be met if a total number of iterations equals or exceeds a predetermined number of iterations nᵢₜₑᵣ. This predetermined number of iterations may comprise a hyperparameter of anonymization methods according to embodiments, and may be determined, e.g., by a data scientist or other domain expert implementing methods according to embodiments using the anonymizing computer (e.g., by configuring the anonymizing computer to perform methods according to embodiments). In other embodiments, the terminating condition can be met if the anonymized sequence of time-series data converges, e.g., if the changes between the anonymized sequence of time-series data become less than a threshold change or otherwise tend towards a magnitude of zero. In some embodiments, if the resulting anonymized sequence of time-series data is under-trained (e.g., the absolute value of correlation is not small enough, which may result from a low learning rate or predetermined number of iterations nᵢₜₑᵣ), the iterative process can be repeated for a subsequent training session using the anonymized sequence of time-series data as an input (in place of the private sequence of time-series data). Completing the iterative method can result in the production of a final sequence of time-series data, which can be output by the anonymizing computer, e.g., to an operator of the anonymizing computer, to a client computer or publication system, or to an anonymization evaluation computer to evaluate the effectiveness of anonymization methods according to embodiments.

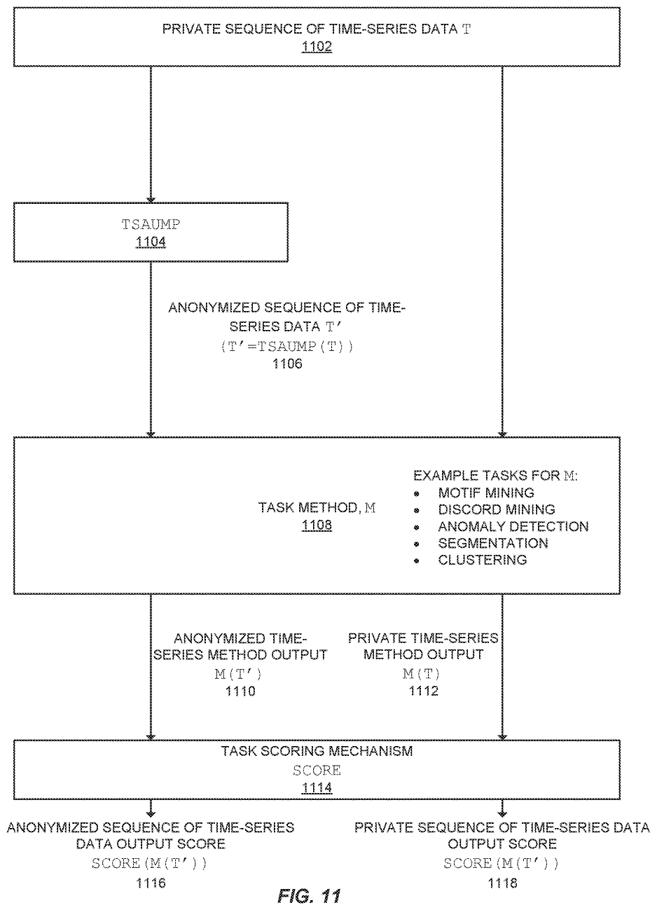

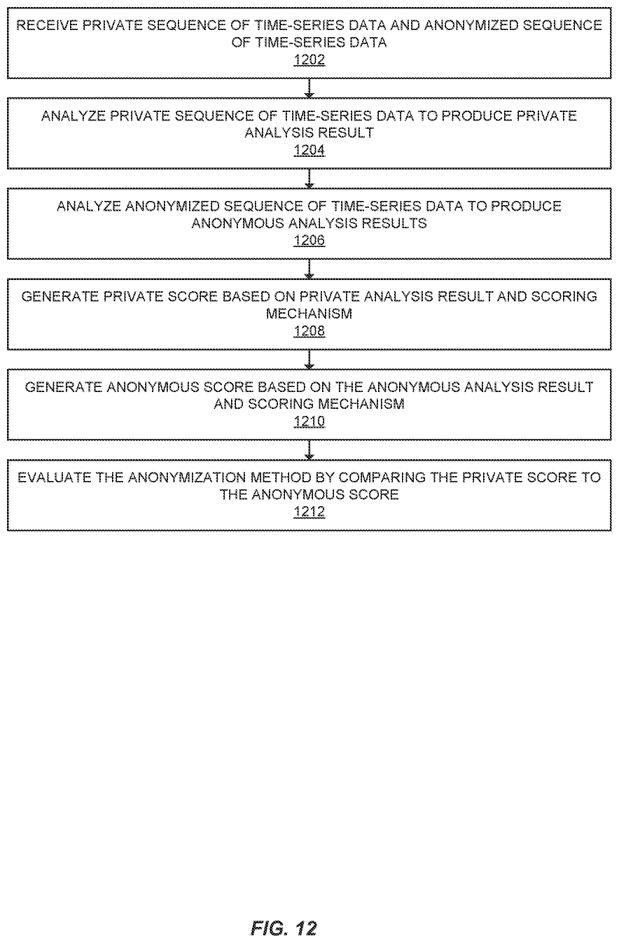

In some embodiments, the final anonymized sequence of time-series data can be analyzed and compared to the private sequence of time-series data, e.g., in order to evaluate the anonymization method at step 722. An exemplary anonymization evaluation method is described in more detail below with reference to FIGS. 11 and 12. Additionally or alternatively, the anonymizing computer can provide the final anonymized sequence of time-series data to a client computer, e.g., at step 724. In some embodiments, providing the anonymized sequence of time-series data can comprise the anonymizing computer transmitting the anonymized sequence of time-series data to the client computer. Alternatively, providing the anonymized sequence of time-series data to the client computer can comprise publishing the anonymized sequence of time-series data (e.g., on a publication system such as publication system 206). The client computer can access the anonymized sequence of time-series data after the anonymized sequence of time-series data has been published. Once the client computer has acquired the anonymized sequence of time-series data, the client computer (or an operator of the client computer, such as a data scientist) can perform analysis on the anonymized sequence of time-series data instead of the private sequence of time-series data. In this way, the privacy of data subjects corresponding to the private sequence of time-series data can be preserved and data scientists or other researchers can still draw useful conclusions from analyzing the anonymized sequence of time-series data.

As stated above, at step 722, the anonymizing computer (or another computer system, such as the anonymization evaluation computer 210 depicted in FIG. 2), can evaluate the effectiveness of anonymization methods according to embodiments and the anonymized sequence of time-series data. An exemplary analysis method is described below with reference to the block diagram of FIG. 11 and the flowchart of FIG. 12. FIG. 11 generally summarizes this analysis method. As depicted in FIG. 11, a private sequence of time-series data 1102 can be anonymized using methods according to embodiments (i.e., TSAUMP 1104) to produce an anonymized sequence of time-series data 1106. A task method 1108 can then be applied to both the private sequence of time-series data 1102 and the anonymized sequence of time-series data 1106. Examples of task methods include motif mining, discord mining, anomaly detection, segmentation, and clustering. The results of task method 1108 can comprise an anonymized time-series method output 1110 and a private time-series method output 1112. For example, if the task method 1108 is an anomaly detection task method, the anonymized time-series method output 1110 can comprise a list of anomalies detected in the anonymized sequence of time-series data 1106. Likewise, the private time-series method output 1112 can comprise a list of anomalies detected in the private sequence of time-series data 1102.

Afterwards, the anonymized time-series method output 1110 and the private time-series method output 1112 can be input into a task scoring mechanism 1114. The task scoring mechanism 1114 can be used to score the performance of the task method 1108 on the anonymized sequence of time-series data 1106 and the private sequence of time-series data 1102. For example, if the location of anomalies in the private sequence of time-series data 1102 are already known (e.g., because the private sequence of time-series data 1102 comprises labeled training data), then the private sequence of time-series data output score 1118 can evaluate how accurately an anomaly detection task method 1108 identified these known anomalies in the private sequence of time-series data 1102. Likewise, the anonymized sequence of time-series data output score 1116 can evaluate how accurately an anomaly detection task method 1108 identified these known anomalies in the anonymized sequence of time-series data 1116. Ideally, if methods according to embodiments fulfill a utility condition (as described above), then the anonymized sequence of time-series data output score 1116 should be similar to the private sequence of time-series data output score 1118.

In more detail, and with reference to FIG. 12, at step 1202, a computer system can receive a private sequence of time-series data comprising one or more private time-series data values, and an anonymized sequence of time-series data comprising one or more anonymized time-series data values. This anonymized sequence of time-series data can be generated by an anonymizing computer based on the private sequence of time-series data using an anonymization method (e.g., as described above). In some embodiments, the computer system can comprise the anonymizing computer, and can effectively receive the anonymized sequence of time-series data and the private sequence of time-series data from itself, e.g., by retrieving the anonymized sequence of time-series data and the private sequence of time-series data from a memory element such as a hard drive. In other embodiments, the computer system can comprise an anonymization evaluation computer (e.g., as depicted in FIG. 2), and can receive the anonymized sequence of time-series data and the private sequence of time-series data from, e.g., an anonymizing computer.

At step 1204, the computer system can analyze the private sequence of time-series data using an analysis procedure, thereby producing a private analysis result. This analysis procedure can comprise, e.g., a task method as described above with reference to FIG. 11. As an example, the private analysis result could comprise the result of a motif or discord mining task applied to the private sequence of time-series data. As another example, the private analysis result could comprise the result of a clustering task applied to the private sequence of time-series data.

At step 1206, the computer system can analyze the anonymized sequence of time-series data using the analysis procedure, thereby producing an anonymous analysis result. The analysis procedure can comprise the same analysis procedure applied to the anonymized sequence of time-series data, such as a motif or discord mining task, or a clustering task. If the utility condition has been satisfied, the anonymous analysis result may be similar to the private analysis result.

At step 1208, the computer system can generate a private score based on the private analysis result and a scoring mechanism, e.g., as depicted in FIG. 11. The scoring mechanism can produce a private score that generally indicates the performance (e.g., the accuracy and precision) of the analysis procedure on the private sequence of time-series data. For example, if the analysis procedure is an anomaly detection method, and the locations of the anomalies in the private sequence of time-series data are known in advance, then the scoring mechanism can produce a private score based on the difference between the private analysis result and the expected private analysis result based on the known anomaly locations.

At step 1210, the computer system can generate an anonymous score based on the anonymous analysis result and the scoring mechanism. The scoring mechanism can produce an anonymous score that generally indicates the performance (e.g., the accuracy and precision) of the analysis procedure on the anonymized sequence of time-series data. If the utility condition has been satisfied, the analysis procedure may achieve similar results on the anonymized sequence of time-series data and the private sequence of time-series data. For example, if the analysis procedure is an anomaly detection method, and the locations of the anomalies in the private sequence of time-series data are known in advance, then the scoring mechanism can produce an anonymous score based on the difference between the anonymous analysis result and the expected private analysis result based on the known anomaly locations.

At step 1212, the computer system can evaluate the anonymization method by comparing the private score to the anonymized score. This can be accomplished in a variety of ways. For example, the computer system can subtract the private score from the anonymized score, e.g., in order to determine the performance difference between the anonymized sequence of time-series data and the private sequence of time-series data. A smaller difference (e.g., closer to zero) may indicate better performance by the anonymization method, while a larger difference may indicate worse performance by the anonymization method.

As described above, a variety of anonymization evaluation methods according to embodiments were used to conduct a series of experiments, in order to test the effectiveness of anonymization methods according to embodiments of the present disclosure. These experiments related to several data analysis tasks such as motif mining, discord mining, segmentation, and clustering. An additional experiment was performed to evaluate some of the statements made above with regard to FIG. 1. That is, this experiment evaluated whether it is possible to design a model that infers sensitive information such as gender (or age) from ECG data, whether anonymized sequences of time-series data generated using methods according to embodiments can prevent such a model from inferring sensitive gender or age related information, and whether anonymized sequences of time-series data are suitable for common time-series analysis tasks, such as anomaly detection.

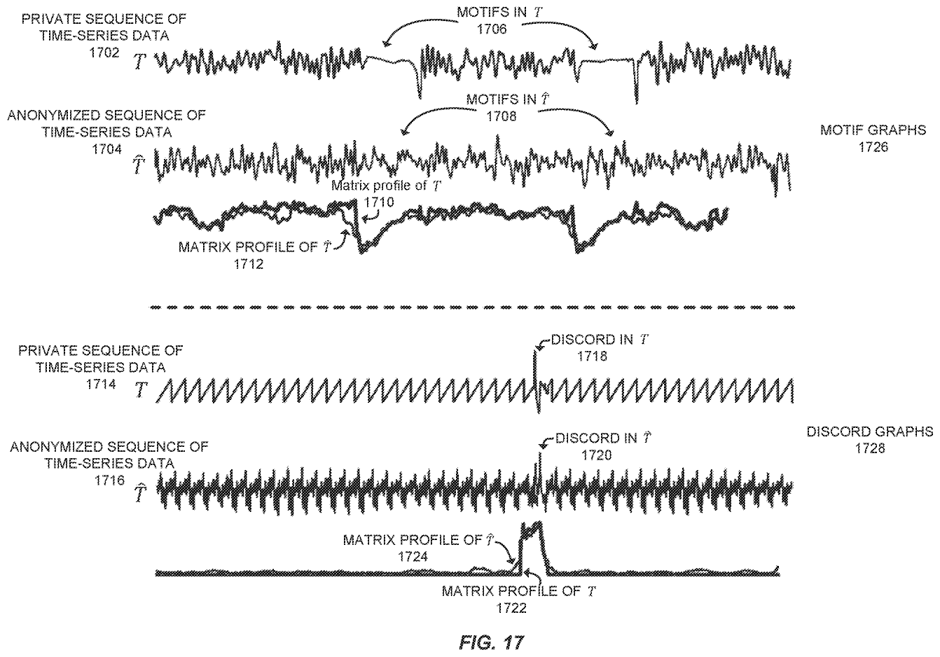

For the motif mining and discord mining experiments (described in more detail below with reference to the motif graphs 1726 and discord graphs 1728 of FIG. 17), a set of “toy” sequences of time-series data were constructed to perform some of these experiments. Techniques similar to those found in [47] were used to construct the toy sequences of time-series data. Motifs and discords were extracted from series in the ECG200 dataset and inserted into random locations in two background signals. For the motif experiment, a private sequence of time-series data was generated by inserting motifs into a background signal comprised a sawtooth wave of length 10,000 with a small amount of Gaussian noise. For the discord experiment, a private sequence of time-series data was generated by inserting discords into a background signal comprised a noiseless sawtooth wave. When computing the matrix profile for each of these toy series, twice the length of the foreground time-series was used as the matrix profile subsequence length. In these experiments, a motif was specifically defined as the subsequence in the time-series that has the smallest distance to its nearest-neighbor [28], and the discord was defined as the subsequence in the time-series that has the greatest distance to its nearest-neighbor.

In these experiments, methods according to embodiments were used to generate an anonymized sequence of time-series data corresponding to the motif mining experiment, as well as an anonymized sequence of time-series data corresponding to the discord mining experiment. The utility of these anonymized sequences of time-series data was evaluated by comparing the matrix profiles of the anonymized sequences of time-series data to the matrix profiles of their corresponding private sequences of time-series data. This was accomplished by determining if the indices of the greatest motif and the greatest discord in both matrix profiles were the same. In these experiments, the differences between the reported and ground truth indices are normalized by the length of the time-series.

FIG. 17 generally summarizes the results of these experiments. Generally, the motif graphs 1726 correspond to the results of the motif mining experiments and the discord graphs 1728 correspond to the results of the discord mining experiments. An exemplary private sequence of time-series data 1702 was constructed using the methods described above, and contains two motifs 1706. This private sequence of time-series data 1702 was used to generate an anonymized sequence of time-series data 1704 using anonymization methods according to embodiments. Like the private sequence of time-series data 1702, the anonymized sequence of time-series data 1708 also contains two motifs 1708.

A matrix profile 1710 corresponding to the private sequence of time-series data 1702 is shown, along with a matrix profile 1712 corresponding to the anonymized sequence of time-series data 1704. As shown in FIG. 17, matrix profiles 1710 and 1712 are generally similar, and both indicate the location of motifs 1706 and 1708, at generally the same indices. Scores were generated and averaged over 100 experimental runs based on the differences in indices of the greatest motif and greatest discord as indicated by the matrix profile 1710 corresponding to the private sequence of time-series data 1702 and the matrix profile 1712 corresponding to the anonymized sequence of time-series data 1704. For the motif mining task, the median score was 0.0046 and the mean score was 0.072.

As stated above, discord graphs 1728 generally correspond to the results of discord mining experiments. A private sequence of time-series data 1714 was constructed using ECG200 training sets as described above. From each training set, the first series of each class was selected and treated as a discord. These discords were inserted at random location in a noiseless sawtooth wave, which was anywhere between ten to fifteen times longer than the discords. An anonymized sequence of time-series data 1716 was generated from the private sequence of time-series data 1714 using methods according to embodiments. Following the definition of a discord provided above, the experiment involved determining if the greatest discord indices were similar in both the matrix profile 1722 corresponding to the private sequence of time-series data 1714 and the matrix profile 1724 corresponding to the anonymized sequence of time-series data 1716. Scores were determined for 100 experimental runs, corresponding to the difference between the greatest discord between the matrix profile 1722 and the matrix profile 1724. For the discord mining task, the median score was 0.0036 and the mean score was 0.0243.

The low mean and median scores for both the motif mining and discord mining experiments demonstrate that matrix profiles generated from anonymized sequences of time-series data are similar to matrix profiles generated from corresponding private sequences of time-series data. This suggests that anonymized sequences of time-series data (generated using methods according to embodiments) can be successfully used in place of private sequences of time-series data for motif mining and discord mining tasks.

As described below, an experiment was conducted to evaluate some of the statements made above with regards to FIG. 1. As a review, FIG. 1 was used to describe potential risks associated with publishing private sequences of time-series data, e.g., that a malicious entity may be able to determine sensitive information from the private sequence of time-series data, even if such information was not included in the private sequence of time-series data. As described above, a malicious individual could conceivably train a model 108 to infer private information, such as gender information from private sequences of ECG data. FIG. 1 was also used to describe a potential use case for embodiments of the present disclosure, e.g., that anonymized sequences of time-series data generated using methods according to embodiments could be used for data analysis tasks, and that models used to determine private information from private sequences of time-series data would be unable to determine such information from anonymized sequences of time-series data. As a result, anonymized sequences of time-series data can be used to protect private or otherwise sensitive information.

As such, experiments were conducted to (1) evaluate whether it is possible to build a model to detect personal information from ECG data, (2) evaluate whether anonymized sequences of time-series data produced using methods according to embodiments can reduce the risk of uncovering personal information, and (3) evaluate whether anonymized sequences of time-series data produced using methods according to embodiments achieve comparable results to corresponding private sequences of time-series data for time-series anomaly detection tasks.

Data from the MIT-BIH Long-Term ECG Database [17] was used to conduct these experiments. This database contains ECG data corresponding to seven patients. 1,000 randomly extracted samples from each patient's first 100,000 data points were used to build a support vector machine (SVM) [13, 31] gender classifier and an SVM age classifier. The length of each sample was 100, and a total of 7,000 training samples (1,000 samples for each of the seven patients) were extracted from the database. The gender and age classifiers were trained as binary classifiers, with the gender classes defined as male and female and the age classes defined as over 60 years old and under 60 years old. The gender and age binary classifiers were built using default SVM settings from Scikit-learn [31]. These gender and age binary classifiers were used to evaluate whether it is possible to build a model to detect personal information from ECG data, and evaluate whether anonymized sequences of time-series data produced using methods according to embodiments can reduce the risk of uncovering personal information.

Further, 1,000 samples were randomly extracted from the second 100,000 data points of each patient. In addition, 7,000 test samples were extracted from both the original (private) sequence of time-series data and an anonymized sequence of time-series data generated using methods according to embodiments. To ensure a fair comparison, the samples were extracted from the same temporal locations for both the private sequence of time-series data and the anonymized sequence of time-series data.

As both the age and gender classifiers are binary classifiers, F1-scores were used as a performance measurement. When the classifiers were applied to test samples from the private sequence of time-series data, the F1-score for gender was 0.8585 and the F1-score for age was 0.9276. In other words, even if gender information and age information is not included in the private sequence of time-series data (or in a dataset from which the private sequence of time-series data was derived), a malicious individual could likely determine such information using models built from public domain data. However, when the classifiers were applied to test samples from the anonymized sequence of time-series data, the F1-score dropped to 0.4635 for gender and 0.3618 for age, indicating that malicious individuals cannot reliably determine this information from anonymized sequence of time-series data, indicating that this sensitive personal information is protected by anonymization methods according to embodiments.

Further, time-series anomaly detection benchmarking experiments similar to Yeh et al. [44] were conducted to evaluate whether anonymized sequences of time-series data produced using methods according to embodiments achieve comparable results to corresponding private series of time-series data in time-series anomaly detection tasks. The second 100,000 data points of each of the seven patients were extracted for the experiment, using normal heartbeats from the first 50,000 data points as training data and the second 50,000 data points as test data. An anomaly detection toolbox was applied to both a private sequence of time-series data and an anonymized sequence of time-series data. The “area under the receiver operating characteristic curve” (AUC) was used to measure the quality of the anomaly score when compared to the ground truth labels. The performance (average AUC over all seven patients) of the 12 methods on both the private sequence of time-series data and the anonymized sequence of time-series data is shown in Table 1 below.

| | Private | Anonymized |
|---|---|---|
| LOF | 0.9531 | 0.9444 |
| IForest | 0.7272 | 0.6977 |
| OCSVM | 0.8006 | 0.8256 |
| AutoReg | 0.5114 | 0.4964 |
| AE | 0.9383 | 0.8882 |
| VAE | 0.8771 | 0.8695 |
| DeepSVDD | 0.6167 | 0.6228 |
| AnoGAN | 0.5773 | 0.4703 |
| LSTM | 0.4859 | 0.4861 |
| GRU | 0.4867 | 0.4857 |
| DAGMM | 0.6443 | 0.6438 |
| MP | 0.9294 | 0.9387 |

AUC was used instead of F1-score because anomaly scores returned by the evaluated methods need to be converted to binary predictions to evaluate F1-scores. As stated by Kim et al. [23], the binarization process for time-series anomaly detection is itself a challenging problem. Therefore, AUC scores were used to avoid additional complications in converting anomaly scores to binary predictions. Aside from AnoGan, the same time-series anomaly detection methods achieves similar performance on both the private sequence of time-series data and the anonymized sequence of time-series data. One possible reason for the inconsistency associated with AnoGAN is that the loss function used in AnoGAN is known to be unstable [5, 6]. The experiment results reported in Table 1 demonstrate that anonymized sequences of time-series data produced using methods according to embodiments achieve comparable results to corresponding private series of time-series data in time-series anomaly detection tasks.

Additionally, time-series segmentation related experiments were performed, and a variety of segmentation methods were benchmarked, including Fast Low-cost Unipotent Semantic Segmentation (FLUSS) [15], Binary Segmentation (Binseg) [8], BottomUp [21], KernelCPD [7, 12], and window-based change point detection (Window). Table 2 below summarizes how well these methods performed on the UCR Segmentation Dataset [15], as well as how well these methods performed on anonymized sequences of time-series data generated using methods according to embodiments. The values in each column comprise mean and median segmentation performance measurements PMseg (proposed by [15]) derived from 32 different time-series. The segmentation performance measurement can be calculated using the following formula:

$$P {M}_{s e g} = ( {\sum }_{i = 1}^{n} min ( \vert \overline{X} - {y}_{i} \vert ) ) / L ,$$

where \vec{y} refers to the model's predicted segmentation points, \vec{X} refers to the ground truth, and L is the length of the time-series. The values can be considered a notion of how far predictions are from their nearest ground truth as a constant in terms of L.

| | | | |
|---|---|---|---|
| Method | Private | Anonymized | Difference |

| | | | | |
|---|---|---|---|---|
| FLUSS | Mean | 0.0326 | 0.0855 | 0.0582 |
| | Median | 0.0061 | 0.0079 | 0.0018 |
| Binseg | Mean | 0.8427 | 1.010 | 0.2215 |
| | Median | 0.9158 | 0.9978 | 0.1713 |
| BottomUp | Mean | 0.7047 | 0.7927 | 0.1857 |
| | Median | 0.7538 | 0.7416 | 0.1519 |
| KernelCPD | Mean | 0.8025 | 0.9540 | 0.2262 |
| | Median | 0.8801 | 0.9816 | 0.1622 |
| Window | Mean | 0.7087 | 0.7779 | 0.1461 |
| | Median | 0.7051 | 0.7241 | 0.1161 |

Table 2 shows small to modest differences between mean and median segmentation performance measurements for the private sequences of time-series data (i.e., the UCR segmentation dataset) and the anonymized sequences of time-series data, indicating that anonymization methods according to embodiments can generate anonymized sequences of time-series data that are useful for segmentation tasks.

Further, clustering experiments were performed which are summarized briefly below. As performed in [47] and in previous experiments, private sequences of time-series data were constructed by generating background sequences of random walks or random noise and embedding samples from the UCR Archive in the foreground. The location of the bounds of each inserted sample was recorded. After anonymization methods according to embodiments are applied to each sequences, anonymized subsequences of time-series data where the original samples were inserted were extracted. The original data was compared to corresponding anonymized subsequence clusters, which demonstrated that datapoints maintained their cluster assignments, indicating that methods according to embodiments can generate anonymized sequences of time-series data that are useful for clustering tasks. Using methods according to embodiments, private sequences of time-series data time-series can be anonymized such that matrix profile information is preserved, but any anonymized motif or discord shapes have zero cross-correlation to corresponding private motif or discord shapes.

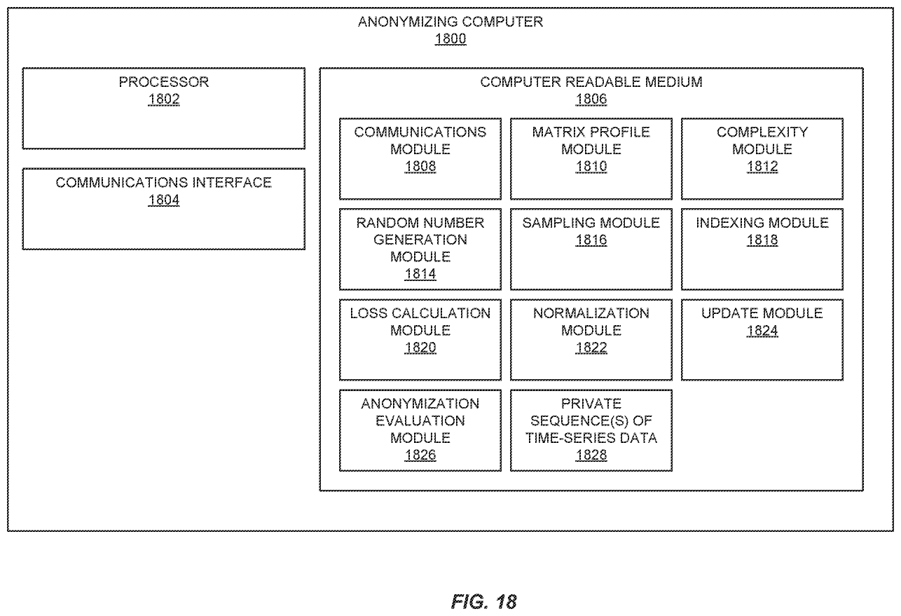

An anonymizing computer (e.g., a computer system that can perform anonymization methods according to embodiments) may be better understood with reference to FIG. 18, which shows an exemplary anonymizing computer 1800 comprising a processor 1802, a communications interface 1804, and a computer readable medium 1806. The computer readable medium 1806 may be non-transitory and coupled to the processor 1802. The computer readable medium 1806 may contain data, code, and/or software modules that may be used by the anonymizing computer 1800 to implement some methods according to embodiments. These data, code, and/or software modules may include a communications module 1808, a matrix profile module 1810, a complexity module 1812, a random number generation module 1814, a sampling module 1816, an indexing module 1818, a loss calculation module 1820, a normalization module 1822, an update module 1824, an anonymization evaluation module 1826, and one or more private sequences of time-series data 1828.

It should be understood that the particular software modules depicted in FIG. 18 were chosen primarily for the purpose of explaining some methods, steps, or other operations according to embodiments, and that FIG. 18 shows only one of a large number of valid anonymizing computer 1800 configurations. In many cases, a single monolithic software application can perform some or all of the functions performed by the software modules depicted in FIG. 18.

Processor 1802 may comprise any suitable data computation device or devices. Processor 1802 may be able to interpret code and carry out instructions stored on computer readable medium 1806. Processor 1802 may comprise a central processing unit (CPU) operating on a reduced instructional set (or any other appropriate instructional set), and may comprise a single or multi-core processor. Processor 1802 may also include an Arithmetic Logic Unit (ALU), a cache memory, and any other structures or components typically associated with processors such as processor 1802. Further description of processors and a list of some example processors is provided above in the terms section.

Communications interface 1804 may comprise any interface by which anonymizing computer 1800 can communicate with other systems, devices, computers, or entities, such as client computers, publication systems, anonymization evaluation computers, or private data sources (e.g., data curators), e.g., as depicted in FIG. 2. Examples of communications interfaces include wired interfaces, such as USB, Ethernet, or FireWire, as well as wireless interfaces such as Bluetooth or Wi-Fi receivers. Anonymizing computer 1800 may possess multiple communications interfaces 1804. As an example, anonymizing computer 1800 may communicate through an Ethernet interfaces, as well as a USB interface. Communications interface 1804 may enable anonymizing computer 1800 to communicate over communications networks such as the Internet.

Communications module 1808 may comprise code, software or instructions that may be interpreted and executed by processor 1802. This software may be used by the anonymizing computer 1800 to communicate with other computers, devices, and entities, such as a client computer, a publication system, a private data source, an anonymization evaluation computer, etc. Particularly, the anonymizing computer 1800 can use communications module 1808 to receive private sequences of time-series data (e.g., from a data source) and transmit anonymized sequences of time-series data (e.g., to a client computer, or to a publication system for publication).

Matrix profile module 1810 may comprise code, software, or instructions that may be interpreted and executed by processor 1802 for performing any of the matrix profile based operations described above, such as generating or otherwise determining matrix profiles and matrix profile indices corresponding to sequences of time-series data. Matrix profile module 1810 may contain code corresponding to any number of appropriate methods for determining, e.g., self-joins or AB-joins in order to compute matrix profiles, such as the SCAMP method [49].

Complexity module 1812 may comprise code, software, or instructions that may be interpreted and executed by processor 1802 in order to determine complexity metrics corresponding to sequences or subsequences of time-series data. The anonymizing computer 1800 may use complexity module 1812 in the calculation of cosmetic losses or complexity losses, as described above.

Random number generation module 1814 may comprise code, software, or instructions that may be interpreted and executed by processor 1802 in order to generate random numbers. The anonymizing computer 1800 may use random number generation module 1814 to initialize an anonymized sequence of time-series data and/or generate random indices used to sample subsequences of time-series data, as described above. The random number generation module 1814 can implement any appropriate random number generation method or methods, including cryptographically secure random number generators.

Sampling module 1816 may comprise code, software, or instructions that may be interpreted and executed by processor 1802 in order to sample subsequences of time-series data, such as a first anonymized subsequence of time-series data and a second anonymized subsequence of time-series data, as described above. Sampling module 1816 may be used by the anonymizing computer in conjunction with indexing module 1818, which may comprise code, software, or instructions that may be interpreted and executed by processor 1802 in order to index sequences and subsequences of time-series data using indices or indicators. Likewise, sampling module 1816 may be used in conjunction with random number generation module 1814 for this purpose. For example, the anonymizing computer 1800 can use random number generation module 1814 to generate random numbers, which can be used as indicators to sample subsequences of time-series data using sampling module 1816 and indexing module 1818.

Loss calculation module 1820 can comprise code, software, or instructions that may be interpreted and executed by processor 1802 in order to calculate a loss or loss value. As described above, in some embodiments, the loss may comprise a combined loss, which may comprise a combination of e.g., a privacy loss (or correlation loss), a utility loss (which itself may comprise a combination of a nearest-neighbor loss and a non-nearest-neighbor loss), and a cosmetic loss (or complexity loss, which may itself comprise a combination of a first complexity loss, a second complexity loss, and a nearest-neighbor complexity loss). The anonymizing computer 1800 can use loss calculation module 1820 to calculate and combine these and other losses, e.g., using the methods described above.

Normalization module 1822 can comprise code, software, or instructions that may be interpreted and executed by processor 1802 in order to normalize sequences and subsequences of time-series data. The anonymizing computer 1802 can use normalization module 1822 to z-normalize sequences or subsequences of time-series data (or use any other appropriate normalization method). Normalizing sequences or subsequences of time-series data using normalization module 1822 may enable anonymizing computer 1800 to calculate z-normalized Euclidean distances, or other data that can be used in performing methods according to embodiments, as described above.

Update module 1824 can comprise code, software, or instructions that may be interpreted and executed by processor 1802 in order to update the anonymized sequence of time-series data during the iterative process described above. The anonymizing computer 1800 can use update module 1824 to perform, e.g., mini-batch stochastic gradient descent, in order to update the anonymized sequence of time-series data based on gradients determined using the loss (which can be determined by the anonymizing computer 1800 using the loss calculation module 1820, as described above). Update module 1824 may be used in conjunction with normalization module 1822, e.g., when updating an anonymized sequence of time-series data using update module 1824, the anonymizing computer 1800 may also z-normalize the anonymized sequence of time-series data using normalization module 1822.

Anonymization evaluation module 1826 may comprise code, software, or instructions that may be interpreted and executed by processor 1802 in order to analyze the effectiveness of anonymization methods. The computer readable medium 1806 may store anonymization evaluation module 1826 if, for example, the anonymizing computer 1800 is also an anonymization evaluation computer, as depicted in FIG. 2 and described in more detail above. The anonymization evaluation module 1826 may enable the anonymization computer 1800 to perform a data analysis method on both an anonymized sequence of time-series data and a private sequence of time-series data, as well as perform a scoring method on the results, thereby evaluating the effectiveness of the anonymization method or the anonymized sequence of time-series data produced by the anonymization method.

Further, the computer readable medium 1806 may store one or more private sequences of time-series data 1828. These one or more private sequences of time-series data may be stored temporarily (e.g., during the performance of methods according to embodiments) and may be removed or otherwise deleted from the computer readable medium 1806 once methods according to embodiments are complete, e.g., if the anonymizing computer 1800 received the one or more private sequences of time-series data from an external data source (e.g., a data curator). Alternatively, however, the anonymizing computer 1800 can store the one or more private sequences of time-series data permanently or for a longer period of time, e.g., if the anonymizing computer 1800 is owned and operated by a data curator. The one or more private sequences of time-series data may be stored in a secure memory element of the computer readable medium, e.g., in order to prevent the one or more private sequences of time-series data from being acquired by malicious entities.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involving computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

### REFERENCES

[1]2020. Personal Information Protection Act. www.pipc.go.kr/cmt/main/english.do
[2]2022. What is GDPR, the EU's new Data Protection Law?https://gdpr.eu/what-is-gdpr/
[3] Martin Abadi, Andy Chu, Ian Goodfellow, H Brendan McMahan, Ilya Mironov, Kunal Talwar, and Li Zhang. 2016. Deep learning with differential privacy. In Proceedings of the 2016 ACM SIGSAC conference on computer and communications security. 308-318.
[4] Simon Duque Anton, Lia Ahrens, Daniel Fraunholz, and Hans Dieter Schotten. 2018. Time is of the essence: Machine learning-based intrusion detection in industrial time series data. In 2018 IEEE International Conference on Data Mining Workshops (ICDMW). IEEE, 1-6.
[5] Martin Arjovsky and Léon Bottou. 2017. Towards principled methods for training generative adversarial networks. arXiv preprint arXiv:1701.04862 (2017).
[6] Martin Arjovsky, Soumith Chintala, and Leon Bottou. 2017. Wasserstein generative adversarial networks. In International conference on machine learning. PMLR, 214-223.
[7] Sylvain Arlot, Alain Celisse, and Zaid Harchaoui. 2019. A kernel multiple change-point algorithm via model selection. Journal of machine learning research 20, 162 (2019).
[8] Jushan Bai. 1997. Estimating multiple breaks one at a time. Econometric theory 13, 3 (1997), 315-352.
[9] Gustavo EAPA Batista, Xiaoyue Wang, and Eamonn J Keogh. 2011. A complexity-invariant distance measure for time series. In Proceedings of the 2011 SIAM inter-national conference on data mining. SIAM, 699-710.
[10] Ane Blezquez-Garcia, Angel Conde, Usue Mori, and Jose A Lozano. 2021. A review on outlier/anomaly detection in time series data. ACM Computing Surveys (CSUR) 54, 3 (2021), 1-33.
[11] Jianneng Cao, Panagiotis Karras, Chedy Raissi, and Kian-Lee Tan. 2010. p-uncertainty: inference-proof transaction anonymization. Proceedings of the VLDB Endowment (PVLDB) 3,1 (2010), 1033-1044.
[12] Alain Celisse, Guillemette Marot, Morgane Pierre-Jean, and GJ Rigaill. 2018. New efficient algorithms for multiple change-point detection with reproducing kernels. Computational Statistics & Data Analysis 128 (2018), 200-220.
[13] Chih-Chung Chang and Chih-Jen Lin. 2011. LIBSVM: a library for support vector machines. ACM transactions on intelligent systems and technology (TIST) 2, 3 (2011), 1-27.
[14] Philippe Esling and Carlos Agon. 2012. Time-series data mining. ACM Computing Surveys (CSUR) 45, 1 (2012), 1-34.
[15] Shaghayegh Gharghabi, Yifei Ding, Chin-Chia Michael Yeh, Kaveh Kamgar, Liudmila Ulanova, and Eamonn Keogh. 2017. Matrix profile VIII: domain agnostic online semantic segmentation at superhuman performance levels. In 2017 IEEE international conference on data mining (ICDM). IEEE, 117-126.
[16] Shaghayegh Gharghabi, Chin-Chia Michael Yeh, Yifei Ding, Wei Ding, Paul Hibbing, Samuel LaMunion, Andrew Kaplan, Scott E Crouter, and Eamonn Keogh. 2019. Domain agnostic online semantic segmentation for multi-dimensional time series. Data mining and knowledge discovery 33, 1 (2019), 96-130.
[17] Ary L Goldberger, Luis A N Amaral, Leon Glass, Jeffrey M Hausdorff, Plamen Ch Ivanov, Roger G Mark, Joseph E Mietus, George B Moody, Chung-Kang Peng, and H Eugene Stanley. 2000. PhysioBank, PhysioToolkit, and PhysioNet: components of a new research resource for complex physiologic signals. circulation 101, 23 (2000), e215-e220.
[18] Chris Holder, Matthew Middlehurst, and Anthony Bagnall. 2022. A Review and Evaluation of Elastic Distance Functions for Time Series Clustering. arXiv preprint arXiv:2205.15181 (2022).
[19] Hassan Ismail Fawaz, Germain Forestier, Jonathan Weber, Lhassane Idoumghar, and Pierre-Alain Muller. 2019. Deep learning for time series classification: a review. Data mining and knowledge discovery 33, 4 (2019), 917-963.
[20] Eamonn Keogh. 2022. The UCR Matrix Profile Page. https://www.cs.ucr.edu/-eamonn/MatrixProfile.html
[21] Eamonn Keogh, Selina Chu, David Hart, and Michael Pazzani. 2004. Segmenting time series: A survey and novel approach. In Data mining in time series databases. World Scientific, 1-21.
[22] Stephan Kessler, Erik Buchmann, Thorben Burghardt, and Klemens B6 hm. 2014. Pattern-sensitive time-series anonymization and its application to energy-consumption data. Open Journal of Information Systems (OJIS) 1, 1 (2014), 3-22.
[23] Siwon Kim, Kukjin Choi, Hyun-Soo Choi, Byunghan Lee, and Sungroh Yoon. 2021. Towards a Rigorous Evaluation of Time-series Anomaly Detection. arXiv preprint arXiv:2109.05257 (2021).
[24] Kwei-Herng Lai, Daochen Zha, Guanchu Wang, Junjie Xu, Yue Zhao, Devesh Kumar, Yile Chen, Purav Zumkhawaka, Minyang Wan, Diego Martinez, et al. 2021. TODS: An automated time series outlier detection system. In Proceedings of the aaai conference on artificial intelligence, Vol. 35. 16060-16062.
[25] Yue Lu, Renjie Wu, Abdullah Mueen, Maria A Zuluaga, and Eamonn Keogh. 2022. Matrix Profile XXIV: Scaling Time Series Anomaly Detection to Trillions of Datapoints and Ultra-fast Arriving Data Streams. In Proceedings of the 28th ACM SIGKDD Conference on Knowledge Discovery and Data Mining. 1173-1182.
[26] Frank Madrid, Shima Imani, Ryan Mercer, Zachary Zimmerman, Nader Shakibay, and Eamonn Keogh. 2019. Matrix profile xx: Finding and visualizing time series motifs of all lengths using the matrix profile. In 2019 IEEE International Conference on Big Knowledge (ICBK). IEEE, 175-182.
[27] Mehdi Mirza and Simon Osindero. 2014. Conditional generative adversarial nets. arXiv preprint arXiv:1411.1784 (2014).
[28] Abdullah Mueen, Eamonn Keogh, Qiang Zhu, Sydney Cash, and Brandon West-over. 2009. Exact discovery of time series motifs. In Proceedings of the 2009 SIAM international conference on data mining. SIAM, 473-484.
[29] Office for Civil Rights. 2022. HIPPA Home. https://www.hhs.gov/hipaa/index. html
[30] Adam Paszke, Sam Gross, Francisco Massa, Adam Lerer, James Bradbury, Gregory Chanan, Trevor Killeen, Zeming Lin, Natalia Gimelshein, Luca Antiga, et al. 2019. Pytorch: An imperative style, high-performance deep learning library. Advances in neural information processing systems 32 (2019).
[31] Fabian Pedregosa, Gasl Varoquaux, Alexandre Gramfort, Vincent Michel, Bertrand Thirion, Olivier Grisel, Mathieu Blondel, Peter Prettenhofer, Ron Weiss, Vincent Dubourg, et al. 2011. Scikit-learn: Machine learning in Python. the Journal of machine Learning research 12 (2011), 2825-2830.
[32] Thanawin Rakthanmanon, Bilson Campana, Abdullah Mueen, Gustavo Batista, Brandon Westover, Qiang Zhu, Jesin Zakaria, and Eamonn Keogh. 2012. Searching and mining trillions of time series subsequences under dynamic time warping. In Proceedings of the 18th ACM SIGKDD international conference on Knowledge discovery and data mining. 262-270.
[33] Dymitr Ruta, Ling Cen, and Ernesto Damiani. 2015. Fast summarization and anonymization of multivariate big time series. In 2015 IEEE International Conference on Big Data (Big Data). IEEE, 1901-1904.
[34] Nader Shakibay Senobari, Gareth J Funning, Eamonn Keogh, Yan Zhu, Chin-Chia Michael Yeh, Zachary Zimmerman, and Abdullah Mueen. 2019. Super-efficient cross-correlation (SEC-C): A fast matched filtering code suitable for desktop computers. Seismological Research Letters 90, 1 (2019), 322-334.
[35] Lidan Shou, Xuan Shang, Ke Chen, Gang Chen, and Chao Zhang. 2011. Supporting pattern-preserving anonymization for time-series data. IEEE Transactions on Knowledge and Data Engineering 25, 4 (2011), 877-892.
[36] Latanya Sweeney. 2002. k-anonymity: A model for protecting privacy. International journal of uncertainty, fuzziness and knowledge-based systems 10, 05 (2002), 557-570.
[37] Laurens Van der Maaten and Geoffrey Hinton. 2008. Visualizing data using t-SNE. Journal of machine learning research 9, 11 (2008).
[38] Shuo Wang, Carsten Rudolph, Surya Nepal, Marthie Grobler, and Shangyu Chen. 2020. PART-GAN: privacy-preserving time-series sharing. In International Conference on Artificial Neural Networks. Springer, 578-593.
[39] Yabo Xu, Ke Wang, Ada Wai-Chee Fu, and Philip S Yu. 2008. Anonymizing transaction databases for publication. In Proceedings of the 14th ACM SIGKDD international conference on Knowledge discovery and data mining. 767-775.
[40] Chin-Chia Michael Yeh. 2018. Towards a near universal time series data mining tool: Introducing the matrix profile. University of California, Riverside.
[41] Chin-Chia Michael Yeh, Nickolas Kavantzas, and Eamonn Keogh. 2017. Matrix profile IV: using weakly labeled time series to predict outcomes. Proceedings of the VLDB Endowment 10, 12 (2017), 1802-1812.
[42] Chin-Chia Michael Yeh, Nickolas Kavantzas, and Eamonn Keogh. 2017. Matrix profile VI: Meaningful multidimensional motif discovery. In 2017 IEEE international conference on data mining (ICDM). IEEE, 565-574.
[43] Chin-Chia Michael Yeh, Helga Van Herle, and Eamonn Keogh. 2016. Matrix profile III: the matrix profile allows visualization of salient subsequences in massive time series. In 2016 IEEE 16th international conference on data mining (ICDM). IEEE, 579-588.
[44] Chin-Chia Michael Yeh, Yan Zheng, Junpeng Wang, Huiyuan Chen, Zhongfang Zhuang, Wei Zhang, and Eamonn Keogh. 2022. Error-bounded Approximate Time Series Joins using Compact Dictionary Representations of Time Series. In Proceedings of the 2022 SIAM International Conference on Data Mining (SDM). SIAM, 181-189.
[45] Chin-Chia Michael Yeh, Yan Zhu, Liudmila Ulanova, Nurjahan Begum, Yifei Ding, Hoang Anh Dau, Diego Furtado Silva, Abdullah Mueen, and Eamonn Keogh. 2016. Matrix profile I: all pairs similarity joins for time series: a unifying view that includes motifs, discords and shapelets. In 2016 IEEE 16th international conference on data mining (ICDM). leee, 1317-1322.
[46] Chin-Chia Michael Yeh, Yan Zhu, Liudmila Ulanova, Nurjahan Begum, Yifei Ding, Hoang Anh Dau, Zachary Zimmerman, Diego Furtado Silva, Abdullah Mueen, and Eamonn Keogh. 2018. Time series joins, motifs, discords and shapelets: a unifying view that exploits the matrix profile. Data Mining and Knowledge Discovery 32, 1 (2018), 83-123.
[47] Yan Zhu, Shaghayegh Gharghabi, Diego Furtado Silva, Hoang Anh Dau, Chin-Chia Michael Yeh, Nader Shakibay Senobari, Abdulaziz Almaslukh, Kaveh Kamgar, Zachary Zimmerman, Gareth Funning, et al. 2020. The Swiss army knife of time series data mining: ten useful things you can do with the matrix profile and ten lines of code. Data Mining and Knowledge Discovery 34, 4 (2020), 949-979.
[48] Yan Zhu, Chin-Chia Michael Yeh, Zachary Zimmerman, Kaveh Kamgar, and Eamonn Keogh. 2018. Matrix profile XI: SCRIMP++: time series motif discovery at interactive speeds. In 2018 IEEE International Conference on Data Mining (ICDM). IEEE, 837-846.
[49] Zachary Zimmerman, Kaveh Kamgar, Nader Shakibay Senobari, Brian Crites, Gareth Funning, Philip Brisk, and Eamonn Keogh. 2019. Matrix profile XIV: scaling time series motif discovery with GPUs to break a quintillion pairwise comparisons a day and beyond. In Proceedings of the ACM Symposium on Cloud Computing. 74-86.

What is claimed is:

1. A method comprising:
receiving, by an anonymizing computer, a private sequence of time-series data comprising one or more private time-series data values;
determining, by the anonymizing computer, a matrix profile and a matrix profile index based on the private sequence of time-series data;
initializing, by the anonymizing computer, an anonymized sequence of time-series data comprising one or more anonymized time-series data values;
performing, by the anonymizing computer, an iterative process to update the anonymized sequence of time-series data, wherein the iterative process comprises:
sampling, by the anonymizing computer, a batch of anonymized subsequences comprising one or more anonymized subsequences from the anonymized sequence of time-series data,
determining, by the anonymizing computer, a batch of anonymized subsequence indicators corresponding to the batch of anonymized subsequences, wherein the batch of anonymized subsequence indicators comprises one or more anonymized subsequence indicators,
determining, by the anonymizing computer, a loss based on the batch of anonymized subsequences, the batch of anonymized subsequence indicators, the private sequence of time-series data, the matrix profile, and the matrix profile index, and
updating, by the anonymizing computer, the anonymized sequence of time-series data based on the loss;
repeating, by the anonymizing computer, the iterative process until a terminating condition has been met, resulting in a final anonymized sequence of time-series data; and
providing, by the anonymizing computer, the final anonymized sequence of time-series data to a client computer.

2. The method of claim 1, wherein updating the anonymized sequence of time-series data comprises updating, by the anonymizing computer, the anonymized sequence of time-series data using mini-batch stochastic gradient descent, and wherein the terminating condition has been met if a total number of iterations equals or exceeds a predetermined number of iterations, or the terminating condition has been met if the anonymized sequence of time-series data converges.

3. The method of claim 1, wherein providing the final anonymized sequence of time-series data to the client computer comprises transmitting, by the anonymizing computer, the final anonymized sequence of time-series data to the client computer, or comprises publishing, by the anonymizing computer, the final anonymized sequence of time-series data, wherein the client computer accesses the final anonymized sequence of time-series data after the final anonymized sequence of time-series data has been published.

4. The method of claim 1, wherein the loss comprises a combined loss, wherein the combined loss comprises a weighted combination of a plurality of losses, wherein the plurality of losses comprises a nearest-neighbor loss and a correlation loss, and wherein the iterative process further comprises:
determining, by the anonymizing computer, the nearest-neighbor loss; and
determining, by the anonymizing computer, the correlation loss.

5. The method of claim 4, wherein determining the nearest-neighbor loss comprises:
determining, by the anonymizing computer, a batch of nearest-neighbor indicators using the matrix profile index and the batch of anonymized subsequence indicators, wherein the batch of nearest-neighbor indicators comprise one or more nearest-neighbor indicators;
determining, by the anonymizing computer, a batch of nearest-neighbor subsequences using the anonymized sequence of time-series data and the batch of nearest-neighbor indicators;
determining, by the anonymizing computer, a batch of nearest-neighbor distances comprising one or more nearest-neighbor distances based on the batch of anonymized subsequences and the batch of nearest-neighbor subsequences;
determining, by the anonymizing computer, a batch of target nearest-neighbor distances comprising one or more target nearest-neighbor distances using the batch of anonymized subsequence indicators and the matrix profile; and
determining, by the anonymizing computer, the nearest-neighbor loss based on the batch of nearest-neighbor distances and the batch of target nearest-neighbor distances.

6. The method of claim 5, wherein determining the nearest-neighbor loss comprises determining, by the anonymizing computer, a mean squared error between the batch of nearest-neighbor distances and the batch of target nearest-neighbor distances, wherein the nearest-neighbor loss comprises the mean squared error.

7. The method of claim 4, wherein determining the correlation loss comprises:
identifying, by the anonymizing computer, a batch of target subsequences using the batch of anonymized subsequences indicators and the private sequence of time-series data, wherein the batch of target subsequences comprise one or more private subsequences from the private sequence of time-series data; and
determining, by the anonymizing computer, the correlation loss based on the batch of anonymized subsequences and the batch of target subsequences, wherein the correlation loss is proportional to a correlation between the batch of anonymized subsequences and the batch of target subsequences.

8. The method of claim 7, wherein the correlation loss is equal to a squared Pearson correlation coefficient, wherein the squared Pearson correlation coefficient corresponds to the correlation between the batch of anonymized subsequences and the batch of target subsequences.

9. The method of claim 7, wherein determining the correlation loss based on the batch of anonymized subsequences and the batch of target subsequences comprises:
determining, by the anonymizing computer, a batch of correlation distances comprising one or more correlation distances using the batch of anonymized subsequences and the batch of target subsequences, wherein each correlation distance of the one or more correlation distances comprises a distance between an anonymized subsequence of the batch of anonymized subsequences and a corresponding target subsequence of the batch of target subsequences; and
determining, by the anonymizing computer, the correlation loss based on the batch of correlation distances and a predetermined subsequence length.

10. The method of claim 4, wherein the plurality of losses additionally comprise a non-nearest-neighbor loss, wherein the batch of anonymized subsequences comprises a first batch of anonymized subsequences, wherein the batch of anonymized subsequence indicators comprises a first batch of anonymized subsequence indicators, and wherein the iterative process further comprises:
sampling, by the anonymizing computer, a second batch of anonymized subsequences comprising one or more second anonymized subsequences from the anonymized sequence of time-series data, wherein the second batch of anonymized subsequences are different from the first batch of anonymized subsequences;
determining, by the anonymizing computer, a second batch of anonymized subsequence indicators corresponding to the second batch of anonymized subsequences, wherein the second batch of anonymized subsequences indicators comprises one or more second anonymized subsequence indicators;
determining, by the anonymizing computer, a batch of nearest-neighbor indicators using the matrix profile index and the first batch of anonymized subsequence indicators, wherein the batch of nearest-neighbor indicators comprise one or more nearest-neighbor indicators;
determining, by the anonymizing computer, a batch of nearest-neighbor subsequences using the anonymized sequence of time-series data and the batch of nearest-neighbor indicators; and
determining, by the anonymizing computer, the non-nearest-neighbor loss based on the first batch of anonymized subsequences, the second batch of anonymized subsequences, and the batch of nearest-neighbor subsequences.

11. The method of claim 10, wherein determining the non-nearest-neighbor loss based on the first batch of anonymized subsequences and the second batch of anonymized subsequences comprises:
determining, by the anonymizing computer, a batch of nearest-neighbor distances comprising one or more nearest-neighbor distances based on the first batch of anonymized subsequences and the batch of nearest-neighbor subsequences;
determining, by the anonymizing computer, a batch of anonymized subsequences distances comprising one or more anonymized subsequences distances using the first batch of anonymized subsequences and the second batch of anonymized subsequences;
determining, by the anonymizing computer, a batch of distance differences based on the batch of nearest-neighbor distances and the batch of anonymized subsequence distances, wherein the batch of distance differences comprises one or more distance differences; and
determining, by the anonymizing computer, the non-nearest-neighbor loss based on the batch of distance differences.

12. The method of claim 11, wherein determining the non-nearest-neighbor loss based on the batch of distance differences comprises:
rectifying, by the anonymizing computer, the batch of distance differences using a rectified linear unit, thereby producing a rectified batch of distance differences comprising one or more rectified distance differences; and
determining, by the anonymizing computer, a sum of the rectified batch of distance differences, wherein the non-nearest-neighbor loss comprises the sum of the rectified batch of distance differences.

13. The method of claim 4, wherein the plurality of losses additionally comprises a cosmetic loss, and wherein the method further comprises determining, by the anonymizing computer, the cosmetic loss.

14. The method of claim 13, wherein:
the weighted combination of the plurality of losses comprises a first weighted combination;
the batch of anonymized subsequences comprises a first batch of anonymized subsequences;
the batch of anonymized subsequence indicators comprises a first batch of anonymized subsequence indicators;
the iterative process further comprises:
sampling, by the anonymizing computer, a second batch of anonymized subsequences comprising one or more second anonymized subsequences from the anonymized sequence of time-series data,
determining, by the anonymizing computer, a second batch of anonymized subsequence indicators corresponding to the second batch of anonymized subsequences, wherein the second batch of anonymized subsequence indicators comprises one or more second anonymized subsequence indicators; and
determining the cosmetic loss comprises:
determining, by the anonymizing computer, a first complexity loss based on the first batch of anonymized subsequences, the first batch of anonymized subsequence indicators, and one or more private subsequence complexity values, wherein the one or more private subsequence complexity values correspond to one or more private subsequences of the private sequence of time-series data, and wherein the first complexity loss corresponds to the first batch of anonymized subsequences,
determining, by the anonymizing computer, a second complexity loss based on the second batch of anonymized subsequences, the second batch of anonymized subsequence indicators, and the one or more private subsequence complexity values, wherein the second complexity loss corresponds to the second batch of anonymized subsequences,
determining, by the anonymizing computer, a nearest-neighbor complexity loss based on a batch of nearest-neighbor subsequences, a batch of nearest-neighbor subsequence indicators, and the one or more private subsequence complexity values, wherein the nearest-neighbor complexity loss corresponds to the batch of nearest-neighbor subsequences, and
determining, by the anonymizing computer, a second weighted combination of the first complexity loss, the second complexity loss, and the nearest-neighbor complexity loss, wherein the cosmetic loss comprises the second weighted combination.

15. The method of claim 14, further comprising:
determining, by the anonymizing computer, a total number of private subsequences in the private sequence of time-series data based on a predetermined subsequence length; and
for each private subsequence of the one or more private subsequences, determining, by the anonymizing computer, a corresponding private subsequence complexity value, thereby determining the one or more private subsequence complexity values, by:
determining, by the anonymizing computer, a private subsequence mean and a private subsequence standard deviation based on the private subsequence,
normalizing, by the anonymizing computer, the private subsequence based on the private subsequence mean and the private subsequence standard deviation, thereby producing a normalized private subsequence,
determining, by the anonymizing computer, one or more private sequential differences, wherein each private sequential difference of the one or more private sequential differences comprises a difference between a normalized private subsequence time-series data value and a sequential normalized private subsequence time-series data value,
determining, by the anonymizing computer, one or more squared private sequential differences by squaring each private sequential difference of the one or more private sequential differences, and
determining, by the anonymizing computer, a sum of the one or more squared private sequential differences, wherein the corresponding private subsequence complexity value comprises the sum of the one or more squared private sequential differences.

16. The method of claim 14, wherein:
determining the first complexity loss comprises:
determining, by the anonymizing computer, one or more first target subsequence complexity values using the one or more private subsequence complexity values and the first batch of anonymized subsequence indicators,
for each first anonymized subsequence of the first batch of anonymized subsequences, determining, by the anonymizing computer, a corresponding first anonymized subsequence complexity value, thereby determining one or more first anonymized subsequence complexity values, and
determining, by the anonymizing computer, a first mean squared error between the one or more first anonymized subsequence complexity values and the one or more first target subsequence complexity values, wherein the first complexity loss comprises the first mean squared error;
determining the second complexity loss comprises:
determining, by the anonymizing computer, one or more second target subsequence complexity values using the one or more private subsequence complexity values and the second batch of anonymized subsequence indicators,
for each second anonymized subsequence of the second batch of anonymized subsequences, determining, by the anonymizing computer, a corresponding second anonymized subsequence complexity value, thereby determining one or more second anonymized subsequence complexity values, and
determining, by the anonymizing computer, a second mean squared error between the one or more second anonymized subsequence complexity values and the one or more second target subsequence complexity values, wherein the second complexity loss comprises the second mean squared error; and
determining the nearest-neighbor complexity loss comprises:
determining, by the anonymizing computer, one or more target nearest-neighbor subsequence complexity values using the one or more private subsequence complexity values and the batch of nearest-neighbor subsequence indicators,
for each nearest-neighbor subsequence of the batch of nearest-neighbor subsequences, determining, by the anonymizing computer, a corresponding nearest-neighbor subsequence complexity value, thereby determining one or more nearest-neighbor subsequence complexity values, and
determining, by the anonymizing computer, a nearest-neighbor mean squared error between the one or more nearest-neighbor subsequence complexity values and the one or more target nearest-neighbor subsequence complexity values, wherein the nearest-neighbor complexity loss comprises the nearest-neighbor mean squared error.

17. The method of claim 16, wherein:
determining the corresponding first anonymized subsequence complexity value comprises:
determining, by the anonymizing computer, one or more first sequential differences, wherein each first sequential difference of the one or more first sequential differences comprises a difference between a first anonymized subsequence time-series data value of the first anonymized subsequence and a sequential first anonymized time-series data value of the first anonymized subsequence,
determining, by the anonymizing computer, one or more squared first sequential differences by squaring each first sequential difference of the one or more first sequential differences, and
determining, by the anonymizing computer, a sum of the one or more squared first sequential differences, wherein the corresponding first anonymized subsequence complexity value comprises the sum of the one or more squared first sequential differences;
determining the corresponding second anonymized subsequence complexity value comprises:
determining, by the anonymizing computer, one or more second sequential differences, wherein each second sequential difference of the one or more second sequential differences comprises a difference between a second anonymized subsequence time-series data value of a second anonymized subsequence and a sequential second anonymized time-series data value of the second anonymized subsequence,
determining, by the anonymizing computer, one or more squared second sequential differences by squaring each second sequential difference of the one or more second sequential differences, and
determining, by the anonymizing computer, a sum of the one or more squared second sequential differences, wherein the corresponding second anonymized subsequence complexity value comprises the sum of the one or more squared second sequential differences; and
determining the corresponding nearest-neighbor subsequence complexity value comprises:
determining, by the anonymizing computer, one or more nearest-neighbor sequential differences, wherein each nearest-neighbor sequential difference of the one or more nearest-neighbor sequential differences comprises a difference between a nearest-neighbor subsequence time-series data value of the nearest-neighbor subsequence and a sequential nearest-neighbor subsequence time-series data value of the nearest-neighbor subsequence,
determining, by the anonymizing computer, one or more squared nearest-neighbor sequential differences by squaring each nearest-neighbor sequential difference of the one or more nearest-neighbor sequential differences, and
determining, by the anonymizing computer, a sum of the one or more squared nearest-neighbor sequential differences, wherein the corresponding nearest-neighbor subsequence complexity value comprises the sum of the one or more squared nearest-neighbor sequential differences.

18. An anonymizing computer comprising:
a processor; and
a non-transitory computer readable medium coupled to the processor, the non-transitory computer readable medium comprising code or instructions, executable by the anonymizing computer, for performing a method comprising:
receiving a private sequence of time-series data comprising one or more private time-series data values;
determining a matrix profile and a matrix profile index based on the private sequence of time-series data;
initializing an anonymized sequence of time-series data comprising one or more anonymized time-series data values;
performing an iterative process to update the anonymized sequence of time-series data, wherein the iterative process comprises:
sampling a batch of anonymized subsequences comprising one or more anonymized subsequences from the anonymized sequence of time-series data,
determining a batch of anonymized subsequence indicators corresponding to the batch of anonymized subsequences, wherein the batch of anonymized subsequence indicators comprise one or more anonymized subsequence indicators,
determining a loss based on the batch of anonymized subsequences, the batch of anonymized subsequence indicators, the private sequence of time-series data, the matrix profile, and the matrix profile index, and
updating the anonymized sequence of time-series data based on the loss;
repeating the iterative process until a terminating condition has been met, resulting in a final anonymized sequence of time-series data; and
providing the final anonymized sequence of time-series data to a client computer.

19. A method comprising:
receiving, by a computer system, a private sequence of time-series data comprising one or more private time-series data values and an anonymized sequence of time-series data comprising one or more anonymized time-series data values, wherein the anonymized sequence of time-series data was generated by an anonymizing computer based on the private sequence of time-series data using an anonymization method;
analyzing, by the computer system, the private sequence of time-series data using an analysis procedure, thereby producing a private analysis result;
analyzing, by the computer system, the anonymizing sequence of time-series data using the analysis procedure, thereby producing an anonymous analysis result;
generating, by the computer system, a private score based on the private analysis result and a scoring mechanism;
generating, by the computer system, an anonymous score based on the anonymous analysis result and the scoring mechanism; and
evaluating, by the computer system, the anonymization method by comparing the private score to the anonymous score.

20. The method of claim 19, wherein the private sequence of time series data comprises user health data, utilities data, computer data or financial data.
